(19) United States
(12) Patent Application Publication
(10) Pub. No.: US 2025/0002768 A1
(43) Pub. Date: Jan. 2, 2025

(54) PHENOL-BASED HOT MELT ADHESIVES FOR REWORK, REPAIR AND RECYCLE

(71) Applicant: Conagen Inc., Bedford, MA (US)

(72) Inventor: John John McNamara, El Sobrante, CA (US)

(73) Assignee: Conagen Inc., Bedford, MA (US)

(21) Appl. No.: 18/824,219

(22) Filed: Sep. 4, 2024

Related U.S. Application Data
(63) Continuation of application No. PCT/US2023/014499, filed on Mar. 3, 2023.
(60) Provisional application No. 63/316,958, filed on Mar. 4, 2022.

(51) Int. Cl. C09J 175/14; C08G 18/32; C08G 18/48; C08G 18/66; C08G 18/67; C08G 18/76; C08G 18/79; C09J 5/06; C09J 175/08

(52) U.S. Cl. CPC C09J 175/14; C08G 18/3206; C08G 18/4858; C08G 18/6677; C08G 18/675; C08G 18/7671; C08G 18/792; C09J 5/06; C09J 175/08

(57) ABSTRACT

The present disclosure provides polymers prepared by a method comprising reacting a polymerization mixture comprising one or more types of diols, one or more types of polyols, and one or more types of isocyanates, wherein at least one type of the diols and/or at least one type of the polyols are phenols, wherein each of the phenols is independently a diol or polyol, wherein one or more instances of —OH, —NH₂, and/or —NH— are aryl-bound. At least one instance of C—OH of at least one instance of the diols or polyols may react with —NCO of the isocyanates to form C—O—C(═O)—NH— bonds. The polymers may be a thermoset under ambient conditions. At elevated temperatures, the polymers may undergo a transition from a cross-linked state to a lightly cross-linked or un-crosslinked state (e.g., at least in part because at least one instance of the C—O—C(═O)—NH— bonds may be cleaved (e.g., to form C—OH and —NCO)). The transition may be reversable (e.g., by changing the temperature). The polymers of the present disclosure may be useful as hot melt adhesives. The present disclosure also provides compositions, kits, methods of preparation, methods of bonding, and methods of de-bonding.

### RELATED APPLICATIONS

This patent application claims priority to U.S. Provisional Patent Application No. 63/316,958, filed Mar. 4, 2022, which is incorporated herein by reference.

### BACKGROUND OF THE DISCLOSURE

Hot melt adhesives are typically dispensed at elevated temperatures. Certain hot melt adhesives are reported in Chinese Patent Application Publication Nos. CN 109705300, CN 109852326, and CN 110396171; and Wang et al., Materials Chemistry Frontiers, 2019, 3, 1833-1839. Known thermoset hot melt adhesives typically comprise isocyanate-functional polyurethane prepolymers that are formulated as un-crosslinked thermoplastics. After heating and dispensing, the thermoset hot melt adhesives may slowly cure into a cross-linked network.

For example, one approach uses polyurethane prepolymers with residual un-reacted isocyanate moieties in the formulation. After dispensing, the adhesive may rely on ambient moisture to initiate the formation of a cross-linked urea network. Adhesive such as these, once cured, may produce interactable cross-linked structures. Thermoset hot melt adhesives may have excellent strength; however, they may have a disadvantage—the adhesion may be so strong that it inhibits or prevents rework, repair, and/or recycle.

For example, Henkel Loctite® HHD 3542 (Loctite®) is a thermoplastic polyurethane isocyanate-functional prepolymer. When heated, Loctite® may melt and can be dispensed from a tube. Loctite® requires ambient atmospheric moisture (e.g., at 50% RH, as shown by the Technical Data Sheet of Loctite®, April 2015) to cure into a strong intractable cross-linked thermoset.

There is a need for improved hot melt adhesives.

### SUMMARY OF THE DISCLOSURE

Oximes may provide dynamic urethane bonds when they are allowed to react with isocyanates (Zhang et al., Chinese J. Polym. Sci., 2021, 39, 1281-1291; and Wang et al., Materials Chemistry Frontiers, 2019, 3, 1833-1839). The resulting materials may possess properties that combine both properties of thermoplastic and thermosetting materials. (Jin et al, Chem. Soc. Rev., 2013 42, 6634-6654; Okino et al. Angew. Chem, Int Ed. 2017, 56, 16597-16601). Applications for materials with dynamic bonding may include self-healing, shape memory, recyclable thermosets, and stimuli-responsive (Kim et al., Adv. Mater., 2018, 30, 1705145; Roy et al., Chem. Soc. Rev., 2015, 44, 3786-3807; Song et al. Angew. Chem., Int. Ed., 2018, 57, 13838-13842, Zou et al. Adv. Mater., 2017, 29, 1606100; Zhang et al. ACS Macro Lett., 2016, 5, 805-808; Lowenberg et al. Acc. Chem. Res., 2017, 50, 723-732; Zhang et al. Adv. Mater., 2016, 28, 7646-7651; Jin et al. Adv. Mater., 2016, 28, 6746-6750; Pei et al. Nat. Mater., 2014, 13, 36-41).

In one aspect, the present disclosure provides polymers with dynamic covalent bonds that decrease the cross-linking density of the polymers at elevated temperatures. In certain embodiments, the polymers are prepared by a method comprising reacting a polymerization mixture comprising one or more types of diols, one or more types of polyols, and one or more types of isocyanates at a first temperature for a first time duration sufficient to forming the polymer, wherein:
each type of the diols is independently a compound comprising zero or more instances of C—OH, zero or more instances of —NH₂, zero or more instances of —NH—, and zero instances of each of ═N—OH and —NCO, wherein the combined number of C—OH, —NH₂, and —NH— of each of the dios is two;
each type of the polyols is independently a compound comprising zero or more instances of C—OH, zero or more instances of —NH₂, zero or more instances of —NH—, and zero instances of each of ═N—OH and —NCO, wherein the combined number of C—OH, —NH₂, and —NH— of each of the polyols is at least three;
at least one type of the diols and/or at least one type of the polyols are phenols, wherein each of the phenols is independently a diol or polyol, wherein one or more instances of —OH, —NH₂, and/or —NH— are aryl-bound; and
each type of the isocyanates is independently a compound comprising two or more instances of —NCO and zero instances of each of —OH, —NH₂, and —NH—.

The polymers of the present disclosure may be crosslinked. The polymers may be a thermoset (e.g., under ambient conditions). In certain embodiments, an instance of —NCO of the isocyanates reacts with an instance of C—OH of the diols or polyols to form a carbamate (e.g. —NH—C(═O)—O—C) bond. In certain embodiments, an instance of —NCO of the isocyanates reacts with an instance of —NH₂ of the diols or polyols to form a urea (e.g., —NH—C(═O)—NH—) bond. In certain embodiments, an instance of —NCO of the isocyanates reacts with an instance of —NH— of the diols or polyols to form a urea (e.g., —NH—C(═O)—N<) bond. In certain embodiments, an instance of —NCO of the isocyanates reacts with an instance of C—NH—C of the diols or polyols to form a urea (e.g.,

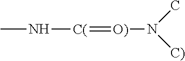

bond. In certain embodiments, the polymer is a polyurethane (e.g., comprising as combined ten or more instances of —NH—C(═O)—O—C). In certain embodiments, the polymer is a polyurea (e.g., comprising as combined ten or more instances of —NH—C(═O)—NH—, —NH—C(═O)—N<, and/or

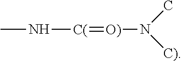

In certain embodiments, the polymer is a polyurethaneurea (e.g., comprising as combined ten or more instances of —NH—C(═O)—O—C, —NH—C(═O)—NH—, —NH—C(═O)—N<, and/or

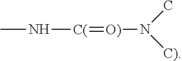

comprising at least one instance of or —NH—C(═O)—O—C, and comprising at least one instance of —NH—C(═O)—NH—, —NH—C(═O)—N<, or

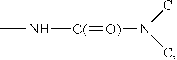

At elevated temperatures (e.g., between 50 and 220° C.), the polymers may undergo a transition from a cross-linked (e.g., thermoset) state to a lightly cross-linked or un-crosslinked (e.g., thermoplastic) state (e.g., at least in part because at least one (e.g., each) instance of the —NH—C(═O)—O—C (e.g., —NH—C(═O)—O-aryl) and/or

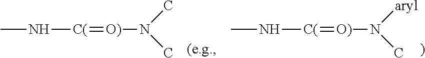

bonds may be cleaved. In certain embodiments, at least one instance (e.g., between 1% and 3%, between 3% and 10%, between 10% and 30%, or between 30% and 90% of the total instances) of —NH—C(═O)—O—C(e.g., —NH—C(═O)—O-aryl) is cleaved to form —NCO and C—OH (e.g., aryl-OH). In certain embodiments, at least one instance (e.g., between 1% and 3%, between 3% and 10%, between 10% and 30%, or between 30% and 90% of the total instances) of

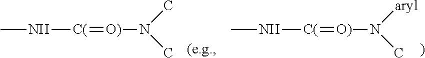

is cleaved to form —NCO and C—NH—C(e.g., C—NH-aryl). The cross-linked state may show higher strength and/or higher toughness than the lightly cross-linked or un-crosslinked state. The lightly cross-linked or un-crosslinked state may show higher flowability than the cross-linked state. The transition may be reversable (e.g., by changing the temperature).

The polymers of the present disclosure may be useful as hot melt adhesives. The polymers may be heated above their transition temperature and allowed to wet and spread over a surface of a first solid material. The polymers may be contacted with a surface of a second solid material. The first and second solid materials may independently be a metal, metal oxides, glass, ceramic, plastic, polymer blend, or composite material. As the polymers cool (e.g., to below the transition temperature), a crosslinked network may reform and produce an adhesive bond between the surface of the first solid material and the surface of the second solid material. The adhesive bond may be de-bonded after its temperature is increased. For example, after heating at or above the transition temperature, the bonding strength may be diminished, and the first and second solid materials may be dissembled at the location where the adhesive bond initially forms. The de-bonding may be useful for recycling (e.g., dissembling the first and second solid materials at the end of life for recycling). The de-bonded first and/or solid materials may be repaired or replaced.

The de-bonded first and second solid materials may be rebonded (e.g., by contacting the polymers on the surface of the first solid material with the polymers on the surface of the second solid material; and curing the polymers on the surface of the first solid material and the polymers on the surface of the second solid material, e.g., at or above the transition temperature). The rebonding may be useful for rework, e.g., to achieve a different bonding (e.g., different bonding location) of the first and second solid materials.

The rebonding may also be useful for repair. The repaired or replaced first solid material and/or the repaired or replaced second solid material may be rebonded at the previous bonding location.

The rebonding may include additional polymers being applied to the surface of a first solid material and/or the surface of the second solid material.

The polymers of the present disclosure may be advantageous over known hot melt adhesives in that, unlike the latter, the former may be de-bondable and/or rebondable. Increased de-bondability and/or rebondability may improve the rework, repair, and/or recycle of the hot melt adhesives. The polymers of the present disclosure may be made into films, cartridges, and other forms suitable for being dispensed as hot melt adhesives.

The polymers of the present disclosure may also be advantageous over known hot melt adhesives in that, unlike the latter, the former may not rely on ambient moisture for cure. None-reliance on ambient moisture for cure may result in more consistent bonding times, faster cure times, and/or production speeds.

The polymers of the present disclosure may also be advantageous over known hot melt adhesives in that the former may be less (e.g., between 10% and 20% less, between 20% and 30% less, between 30% and 50% less, between 50% and 70% less, or between 70% and 99% less) toxic to a subject (e.g., a human) than the latter (e.g., at least in part because each type of the diols and each type of the polyols comprise zero instances of ═N—OH).

The polymers of the present disclosure may be advantageous over known hot melt adhesives in that the former may be more (e.g., between 2- and 4-fold more, between 4- and 7-fold more, between 7- and 10-fold more, between 10- and 30-fold more, between 30- and 100-fold more, or between 100- and 1,000-fold more) transparent (e.g., as more transparent films) than the latter. The polymers of the present disclosure may be useful when optics are important, e.g., as optical clear adhesives, e.g., for displays and other electronic applications.

In certain embodiments, at least one (e.g., each) type of the diols and/or at least one (e.g. each) type of the polyols is a phenol. The phenol may facilitate the bonding and/or de-bonding of the polymer to/from a solid substrate (e.g., by forming a carbamate that is cleaved at elevated temperatures).

In certain embodiments, the phenol comprises one or more primary and/or secondary amines. The primary and/or secondary amines may form urea bonds. The secondary amines may facilitate the bonding of the polymers to a solid substrate (e.g., by forming urea bonds). The secondary amines may also facilitate the de-bonding of the polymers from the solid substrate (e.g., by cleaving the urea bonds at elevated temperatures). In certain embodiments, the phenol comprises one or more primary amines, which may improve toughness of the polymer.

The polymers of the present disclosure may also be advantageous over known hot melt adhesives in that the former may show higher (e.g., between 2- and 3-fold higher, between 3- and 5-fold higher, between 5- and 7-fold higher, between 7- and 10-fold higher, between 10- and 30-fold higher, or between 30- and 100-fold higher) toughness (e.g., higher resistance to heat) than the latter.

The polymers of the present disclosure may also be advantageous over known hot melt adhesives in that the former may show higher (e.g., between 2- and 3-fold higher, between 3- and 5-fold higher, between 5- and 7-fold higher, between 7- and 10-fold higher, between 10- and 30-fold higher, or between 30- and 100-fold higher) strength (e.g., higher de-bonding force) than the latter.

The polymers of the present disclosure may also be advantageous over known hot melt adhesives in that the former may show higher toughness (e.g., higher resistance to heat) than the latter.

The polymers of the present disclosure may also be advantageous over known hot melt adhesives in that the former may show higher strength (e.g., higher de-bonding force) than the latter.

The polymers of the present disclosure may also be advantageous over known hot melt adhesives in that the former may show higher (e.g., between 2- and 3-fold higher, between 3- and 5-fold higher, between 5- and 7-fold higher, between 7- and 10-fold higher, between 10- and 30-fold higher, or between 30- and 100-fold higher) toughness (e.g., higher resistance to heat) than the latter.

The polymers of the present disclosure may also be advantageous over known hot melt adhesives in that the former may show higher (e.g., between 2- and 3-fold higher, between 3- and 5-fold higher, between 5- and 7-fold higher, between 7- and 10-fold higher, between 10- and 30-fold higher, or between 30- and 100-fold higher) strength (e.g., higher de-bonding force) than the latter.

### Definitions

Definitions of specific functional groups and chemical terms are described in more detail below. The chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5^{th} Edition, John Wiley & Sons, Inc., New York, 2001; Larock, Comprehensive Organic Transformations, VCH Publishers, Inc., New York, 1989; and Carruthers, Some Modern Methods of Organic Synthesis, 3^{rd} Edition, Cambridge University Press, Cambridge, 1987.

Compounds described herein can comprise one or more asymmetric centers, and thus can exist in various stereoisomeric forms, e.g., enantiomers and/or diastereomers. For example, the compounds described herein can be in the form of an individual enantiomer, diastereomer or geometric isomer, or can be in the form of a mixture of stereoisomers, including racemic mixtures and mixtures enriched in one or more stereoisomer. Isomers can be isolated from mixtures by methods known to those skilled in the art, including chiral high pressure liquid chromatography (HPLC) and the formation and crystallization of chiral salts; or preferred isomers can be prepared by asymmetric syntheses. See, for example, Jacques et al., Enantiomers, Racemates and Resolutions (Wiley Interscience, New York, 1981); Wilen et al., Tetrahedron 33:2725 (1977); Eliel, E. L. Stereochemistry of Carbon Compounds (McGraw-Hill, NY, 1962); and Wilen, S. H. Tables of Resolving Agents and Optical Resolutions p. 268 (E. L. Eliel, Ed., Univ. of Notre Dame Press, Notre Dame, IN 1972). The invention additionally encompasses compounds as individual isomers substantially free of other isomers, and alternatively, as mixtures of various isomers.

In a formula, the bond [symbol] is a single bond, the dashed line [symbol] is a single bond or absent, and the bond [symbol] or [symbol] is a single or double bond.

Unless otherwise provided, a formula depicted herein includes compounds that do not include isotopically enriched atoms and also compounds that include isotopically enriched atoms. Compounds that include isotopically enriched atoms may be useful as, for example, analytical tools, and/or probes in biological assays.

When a range of values (“range”) is listed, it is intended to encompass each value and subrange within the range. A range is inclusive of the values at the two ends of the range unless otherwise provided. For example “C₁₋₆ alkyl” is intended to encompass, C₁, C₂, C₃, C₄, C₅, C₆, C₁₋₆, C₁₋₅, C₁₋₄, C₁₋₃, C₁₋₂, C₂₋₆, C₂₋₅, C₂₋₄, C₂₋₃, C₃₋₆, C₃₋₅, C₃₋₄, C₄₋₆, C₄₋₅, and C₅₋₆ alkyl.

The term “aliphatic” refers to alkyl, alkenyl, alkynyl, and carbocyclic groups. Likewise, the term “heteroaliphatic” refers to heteroalkyl, heteroalkenyl, heteroalkynyl, and heterocyclic groups.

The term “alkyl” refers to a radical of a straight-chain or branched saturated hydrocarbon group having from 1 to 20 carbon atoms (“C₁₋₂₀ alkyl”). In some embodiments, an alkyl group has 1 to 12 carbon atoms (“C₁₋₁₂ alkyl”). In some embodiments, an alkyl group has 1 to 10 carbon atoms (“C₁₋₁₀ alkyl”). In some embodiments, an alkyl group has 1 to 8 carbon atoms (“C₁₋₈ alkyl”). In some embodiments, an alkyl group has 1 to 7 carbon atoms (“C₁₋₇ alkyl”). In some embodiments, an alkyl group has 1 to 6 carbon atoms (“C₁₋₆ alkyl”). In some embodiments, an alkyl group has 1 to 5 carbon atoms (“C₁₋₅ alkyl”). In some embodiments, an alkyl group has 1 to 4 carbon atoms (“C₁₋₄ alkyl”). In some embodiments, an alkyl group has 1 to 3 carbon atoms (“C₁₋₃ alkyl”). In some embodiments, an alkyl group has 1 to 2 carbon atoms (“C₁₋₂ alkyl”). In some embodiments, an alkyl group has 1 carbon atom (“C₁ alkyl”). In some embodiments, an alkyl group has 2 to 6 carbon atoms (“C₂₋₆ alkyl”). Examples of C₁₋₆ alkyl groups include methyl (C₁), ethyl (C₂), propyl (C₃) (e.g., n-propyl, isopropyl), butyl (C₄) (e.g., n-butyl, tert-butyl, sec-butyl, iso-butyl), pentyl (C₅) (e.g., n-pentyl, 3-pentanyl, amyl, neopentyl, 3-methyl-2-butanyl, tertiary amyl), and hexyl (C₆) (e.g., n-hexyl). Additional examples of alkyl groups include n-heptyl (C₇), n-octyl (C₈), and the like. Unless otherwise specified, each instance of an alkyl group is independently unsubstituted (an “unsubstituted alkyl”) or substituted (a “substituted alkyl”) with one or more substituents (e.g., halogen, such as F). In certain embodiments, the alkyl group is an unsubstituted C₁₋₁₂ alkyl (such as unsubstituted C₁₋₆ alkyl, e.g., —CH₃ (Me), unsubstituted ethyl (Et), unsubstituted propyl (Pr, e.g., unsubstituted n-propyl (n-Pr), unsubstituted isopropyl (i-Pr)), unsubstituted butyl (Bu, e.g., unsubstituted n-butyl (n-Bu), unsubstituted tert-butyl (tert-Bu or t-Bu), unsubstituted sec-butyl (sec-Bu or s-Bu), unsubstituted isobutyl (i-Bu)). In certain embodiments, the alkyl group is a substituted C₁₋₁₂ alkyl (such as substituted C₁₋₆ alkyl, e.g., —CH₂F, —CHF₂, —CF₃, —CH₂CH₂F, —CH₂CHF₂, —CH₂CF₃, or benzyl (Bn)).

The term “haloalkyl” is a substituted alkyl group, wherein one or more of the hydrogen atoms are independently replaced by a halogen, e.g., fluoro, bromo, chloro, or iodo. “Perhaloalkyl” is a subset of haloalkyl, and refers to an alkyl group wherein all of the hydrogen atoms are independently replaced by a halogen, e.g., fluoro, bromo, chloro, or iodo. In some embodiments, the haloalkyl moiety has 1 to 20 carbon atoms (“C₁₋₂₀ haloalkyl”). In some embodiments, the haloalkyl moiety has 1 to 12 carbon atoms (“C₁₋₁₂ haloalkyl”). In some embodiments, the haloalkyl moiety has 1 to 8 carbon atoms (“C₁₋₅ haloalkyl”). In some embodiments, the haloalkyl moiety has 1 to 6 carbon atoms (“C₁₋₆ haloalkyl”). In some embodiments, the haloalkyl moiety has 1 to 4 carbon atoms (“C₁₋₄ haloalkyl”). In some embodiments, the haloalkyl moiety has 1 to 3 carbon atoms (“C₁₋₃ haloalkyl”). In some embodiments, the haloalkyl moiety has 1 to 2 carbon atoms (“C₁₋₂ haloalkyl”). In some embodiments, all of the haloalkyl hydrogen atoms are replaced with fluoro to provide a perfluoroalkyl group. In some embodiments, all of the haloalkyl hydrogen atoms are replaced with chloro to provide a “perchloroalkyl” group. Examples of haloalkyl groups include —CF₃, —CF₂CF₃, —CF₂CF₂CF₃, —CCl₃, —CFCl₂, —CF₂Cl, and the like.

The term “heteroalkyl” refers to an alkyl group, which further includes at least one heteroatom (e.g., 1, 2, 3, or 4 heteroatoms) selected from oxygen, nitrogen, or sulfur within (i.e., inserted between adjacent carbon atoms of) and/or placed at one or more terminal position(s) of the parent chain. In certain embodiments, a heteroalkyl group refers to a saturated group having from 1 to 20 carbon atoms and 1 or more heteroatoms within the parent chain (“heteroC₁₋₂₀ alkyl” or “C₁₋₂₀ heteroalkyl”). In certain embodiments, a heteroalkyl group refers to a saturated group having from 1 to 12 carbon atoms and 1 or more heteroatoms within the parent chain (“heteroC₁₋₁₂ alkyl”). In certain embodiments, a heteroalkyl group refers to a saturated group having from 1 to 10 carbon atoms and 1 or more heteroatoms within the parent chain (“heteroC₁₋₁₀ alkyl”). In some embodiments, a heteroalkyl group is a saturated group having 1 to 9 carbon atoms and 1 or more heteroatoms within the parent chain (“heteroC₁₋₉ alkyl”). In some embodiments, a heteroalkyl group is a saturated group having 1 to 8 carbon atoms and 1 or more heteroatoms within the parent chain (“heteroC₁₋₈ alkyl”). In some embodiments, a heteroalkyl group is a saturated group having 1 to 7 carbon atoms and 1 or more heteroatoms within the parent chain (“heteroC₁₋₇ alkyl”). In some embodiments, a heteroalkyl group is a saturated group having 1 to 6 carbon atoms and 1 or more heteroatoms within the parent chain (“heteroC₁₋₆ alkyl”). In some embodiments, a heteroalkyl group is a saturated group having 1 to 5 carbon atoms and 1 or 2 heteroatoms within the parent chain (“heteroC₁₋₅ alkyl”). In some embodiments, a heteroalkyl group is a saturated group having 1 to 4 carbon atoms and 1 or 2 heteroatoms within the parent chain (“heteroC₁₋₄ alkyl”). In some embodiments, a heteroalkyl group is a saturated group having 1 to 3 carbon atoms and 1 heteroatom within the parent chain (“heteroC₁₋₃ alkyl”). In some embodiments, a heteroalkyl group is a saturated group having 1 to 2 carbon atoms and 1 heteroatom within the parent chain (“heteroC₁₋₂ alkyl”). In some embodiments, a heteroalkyl group is a saturated group having 1 carbon atom and 1 heteroatom (“heteroC₁ alkyl”). In some embodiments, a heteroalkyl group is a saturated group having 2 to 6 carbon atoms and 1 or 2 heteroatoms within the parent chain (“heteroC₂₋₆ alkyl”). Unless otherwise specified, each instance of a heteroalkyl group is independently unsubstituted (an “unsubstituted heteroalkyl”) or substituted (a “substituted heteroalkyl”) with one or more substituents. In certain embodiments, the heteroalkyl group is an unsubstituted heteroC₁₋₁₀ alkyl. In certain embodiments, the heteroalkyl group is a substituted heteroC₁₋₁₀ alkyl.

The term “alkenyl” refers to a radical of a straight-chain or branched hydrocarbon group having from 1 to 20 carbon atoms and one or more carbon-carbon double bonds (e.g., 1, 2, 3, or 4 double bonds) (“C₁₋₂₀ alkenyl”). In some embodiments, an alkenyl group is ═CH₂. In some embodiments, an alkenyl group has 2 to 20 carbon atoms (“C₂₋₂₀ alkenyl”). In some embodiments, an alkenyl group is ═CH₂. In some embodiments, an alkenyl group has 2 to 12 carbon atoms (“C₂₋₁₂ alkenyl”). In some embodiments, an alkenyl group has 2 to 9 carbon atoms (“C₂₋₉ alkenyl”). In some embodiments, an alkenyl group has 2 to 8 carbon atoms (“C₂₋₈ alkenyl”). In some embodiments, an alkenyl group has 2 to 7 carbon atoms (“C₂₋₇ alkenyl”). In some embodiments, an alkenyl group has 2 to 6 carbon atoms (“C₂₋₆ alkenyl”). In some embodiments, an alkenyl group has 2 to 5 carbon atoms (“C₂₋₅ alkenyl”). In some embodiments, an alkenyl group has 2 to 4 carbon atoms (“C₂₋₄ alkenyl”). In some embodiments, an alkenyl group has 2 to 3 carbon atoms (“C₂₋₃ alkenyl”). In some embodiments, an alkenyl group has 2 carbon atoms (“C₂ alkenyl”). The one or more carbon-carbon double bonds can be internal (such as in 2-butenyl) or terminal (such as in 1-butenyl). Examples of C₂₋₄ alkenyl groups include ethenyl (C₂), 1-propenyl (C₃), 2-propenyl (C₃), 1-butenyl (C₄), 2-butenyl (C₄), butadienyl (C₄), and the like. Examples of C₂₋₆ alkenyl groups include the aforementioned C₂₋₄ alkenyl groups as well as pentenyl (C₅), pentadienyl (C₅), hexenyl (C₆), and the like. Additional examples of alkenyl include heptenyl (C₇), octenyl (C₈), octatrienyl (C₈), and the like. Unless otherwise specified, each instance of an alkenyl group is independently unsubstituted (an “unsubstituted alkenyl”) or substituted (a “substituted alkenyl”) with one or more substituents. In certain embodiments, the alkenyl group is an unsubstituted C₂₋₁₀ alkenyl. In certain embodiments, the alkenyl group is a substituted C₂₋₁₀ alkenyl. In an alkenyl group, a C═C double bond for which the stereochemistry is not specified

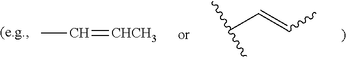

may be in the (E)- or (Z)-configuration.

The term “heteroalkenyl” refers to an alkenyl group, which further includes at least one heteroatom (e.g., 1, 2, 3, or 4 heteroatoms) selected from oxygen, nitrogen, or sulfur within (i.e., inserted between adjacent carbon atoms of) and/or placed at one or more terminal position(s) of the parent chain. In certain embodiments, a heteroalkenyl group refers to a group having from 2 to 20 carbon atoms, at least one double bond, and 1 or more heteroatoms within the parent chain (“heteroC₂₋₂₀ alkenyl” or “C₂₋₂₀ heteroalkenyl”). In certain embodiments, a heteroalkenyl group refers to a group having from 2 to 12 carbon atoms, at least one double bond, and 1 or more heteroatoms within the parent chain (“heteroC₂₋₁₂ alkenyl”). In certain embodiments, a heteroalkenyl group refers to a group having from 2 to 10 carbon atoms, at least one double bond, and 1 or more heteroatoms within the parent chain (“heteroC₂₋₁₀ alkenyl”). In some embodiments, a heteroalkenyl group has 2 to 9 carbon atoms at least one double bond, and 1 or more heteroatoms within the parent chain (“heteroC₂₋₉ alkenyl”). In some embodiments, a heteroalkenyl group has 2 to 8 carbon atoms, at least one double bond, and 1 or more heteroatoms within the parent chain (“heteroC₂₋₈ alkenyl”). In some embodiments, a heteroalkenyl group has 2 to 7 carbon atoms, at least one double bond, and 1 or more heteroatoms within the parent chain (“heteroC₂₋₇ alkenyl”). In some embodiments, a heteroalkenyl group has 2 to 6 carbon atoms, at least one double bond, and 1 or more heteroatoms within the parent chain (“heteroC₂₋₆ alkenyl”). In some embodiments, a heteroalkenyl group has 2 to 5 carbon atoms, at least one double bond, and 1 or 2 heteroatoms within the parent chain (“heteroC₂₋₅ alkenyl”). In some embodiments, a heteroalkenyl group has 2 to 4 carbon atoms, at least one double bond, and 1 or 2 heteroatoms within the parent chain (“heteroC₂₋₄ alkenyl”). In some embodiments, a heteroalkenyl group has 2 to 3 carbon atoms, at least one double bond, and 1 heteroatom within the parent chain (“heteroC₂₋₃ alkenyl”). In some embodiments, a heteroalkenyl group has 2 to 6 carbon atoms, at least one double bond, and 1 or 2 heteroatoms within the parent chain (“heteroC₂₋₆ alkenyl”). Unless otherwise specified, each instance of a heteroalkenyl group is independently unsubstituted (an “unsubstituted heteroalkenyl”) or substituted (a “substituted heteroalkenyl”) with one or more substituents. In certain embodiments, the heteroalkenyl group is an unsubstituted heteroC₂₋₁₀ alkenyl. In certain embodiments, the heteroalkenyl group is a substituted heteroC₂₋₁₀ alkenyl.

The term “alkynyl” refers to a radical of a straight-chain or branched hydrocarbon group having from 1 to 20 carbon atoms and one or more carbon-carbon triple bonds (e.g., 1, 2, 3, or 4 triple bonds) (“C₁₋₂₀ alkynyl”). In some embodiments, an alkynyl group is ≡CH. In some embodiments, an alkynyl group has 2 to 20 carbon atoms (“C₂₋₂₀ alkynyl”). In some embodiments, an alkynyl group has 2 to 12 carbon atoms (“C₂₋₁₂ alkynyl”). In some embodiments, an alkynyl group has 2 to 9 carbon atoms (“C₂₋₉ alkynyl”). In some embodiments, an alkynyl group has 2 to 8 carbon atoms (“C₂₋₈ alkynyl”). In some embodiments, an alkynyl group has 2 to 7 carbon atoms (“C₂₋₇ alkynyl”). In some embodiments, an alkynyl group has 2 to 6 carbon atoms (“C₂₋₆ alkynyl”). In some embodiments, an alkynyl group has 2 to 5 carbon atoms (“C₂₋₅ alkynyl”). In some embodiments, an alkynyl group has 2 to 4 carbon atoms (“C₂₋₄ alkynyl”). In some embodiments, an alkynyl group has 2 to 3 carbon atoms (“C₂₋₃ alkynyl”). In some embodiments, an alkynyl group has 2 carbon atoms (“C₂ alkynyl”). The one or more carbon-carbon triple bonds can be internal (such as in 2-butynyl) or terminal (such as in 1-butynyl). Examples of C₂₋₄ alkynyl groups include ethynyl (C₂), 1-propynyl (C₃), 2-propynyl (C₃), 1-butynyl (C₄), 2-butynyl (C₄), and the like. Examples of C₂₋₆ alkenyl groups include the aforementioned C₂₋₄ alkynyl groups as well as pentynyl (C₅), hexynyl (C₆), and the like. Additional examples of alkynyl include heptynyl (C₇), octynyl (C₈), and the like. Unless otherwise specified, each instance of an alkynyl group is independently unsubstituted (an “unsubstituted alkynyl”) or substituted (a “substituted alkynyl”) with one or more substituents. In certain embodiments, the alkynyl group is an unsubstituted C₂₋₁₀ alkynyl. In certain embodiments, the alkynyl group is a substituted C₂₋₁₀ alkynyl.

The term “heteroalkynyl” refers to an alkynyl group, which further includes at least one heteroatom (e.g., 1, 2, 3, or 4 heteroatoms) selected from oxygen, nitrogen, or sulfur within (i.e., inserted between adjacent carbon atoms of) and/or placed at one or more terminal position(s) of the parent chain. In certain embodiments, a heteroalkynyl group refers to a group having from 2 to 20 carbon atoms, at least one triple bond, and 1 or more heteroatoms within the parent chain (“heteroC₂₋₂₀ alkynyl” or “C₂₋₂₀ heteralkynyl”). In certain embodiments, a heteroalkynyl group refers to a group having from 2 to 12 carbon atoms, at least one triple bond, and 1 or more heteroatoms within the parent chain (“heteroC₂₋₁₂ alkynyl”). In certain embodiments, a heteroalkynyl group refers to a group having from 2 to 10 carbon atoms, at least one triple bond, and 1 or more heteroatoms within the parent chain (“heteroC₂₋₁₀ alkynyl”). In some embodiments, a heteroalkynyl group has 2 to 9 carbon atoms, at least one triple bond, and 1 or more heteroatoms within the parent chain (“heteroC₂₋₉ alkynyl”). In some embodiments, a heteroalkynyl group has 2 to 8 carbon atoms, at least one triple bond, and 1 or more heteroatoms within the parent chain (“heteroC₂₋₈ alkynyl”). In some embodiments, a heteroalkynyl group has 2 to 7 carbon atoms, at least one triple bond, and 1 or more heteroatoms within the parent chain (“heteroC₂₋₇ alkynyl”). In some embodiments, a heteroalkynyl group has 2 to 6 carbon atoms, at least one triple bond, and 1 or more heteroatoms within the parent chain (“heteroC₂₋₆ alkynyl”). In some embodiments, a heteroalkynyl group has 2 to 5 carbon atoms, at least one triple bond, and 1 or 2 heteroatoms within the parent chain (“heteroC₂₋₅ alkynyl”). In some embodiments, a heteroalkynyl group has 2 to 4 carbon atoms, at least one triple bond, and 1 or 2 heteroatoms within the parent chain (“heteroC₂₋₄ alkynyl”). In some embodiments, a heteroalkynyl group has 2 to 3 carbon atoms, at least one triple bond, and 1 heteroatom within the parent chain (“heteroC₂₋₃ alkynyl”). In some embodiments, a heteroalkynyl group has 2 to 6 carbon atoms, at least one triple bond, and 1 or 2 heteroatoms within the parent chain (“heteroC₂₋₆ alkynyl”). Unless otherwise specified, each instance of a heteroalkynyl group is independently unsubstituted (an “unsubstituted heteroalkynyl”) or substituted (a “substituted heteroalkynyl”) with one or more substituents. In certain embodiments, the heteroalkynyl group is an unsubstituted heteroC₂₋₁₀ alkynyl. In certain embodiments, the heteroalkynyl group is a substituted heteroC₂₋₁₀ alkynyl.

The term “carbocyclyl” or “carbocyclic” refers to a radical of a non-aromatic cyclic hydrocarbon group having from 3 to 14 ring carbon atoms (“C₃₋₁₄ carbocyclyl”) and zero heteroatoms in the non-aromatic ring system. In some embodiments, a carbocyclyl group has 3 to 10 ring carbon atoms (“C₃₋₁₀ carbocyclyl”). In some embodiments, a carbocyclyl group has 3 to 8 ring carbon atoms (“C₃₋₈ carbocyclyl”). In some embodiments, a carbocyclyl group has 3 to 7 ring carbon atoms (“C₃₋₇ carbocyclyl”). In some embodiments, a carbocyclyl group has 3 to 6 ring carbon atoms (“C₃₋₆ carbocyclyl”). In some embodiments, a carbocyclyl group has 4 to 6 ring carbon atoms (“C₄₋₆ carbocyclyl”). In some embodiments, a carbocyclyl group has 5 to 6 ring carbon atoms (“C₅₋₆ carbocyclyl”). In some embodiments, a carbocyclyl group has 5 to 10 ring carbon atoms (“C₅₋₁₀ carbocyclyl”). Exemplary C₃₋₆ carbocyclyl groups include cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), and the like. Exemplary C₃₋₈ carbocyclyl groups include the aforementioned C₃₋₆ carbocyclyl groups as well as cycloheptyl (C₇), cycloheptenyl (C₇), cycloheptadienyl (C₇), cycloheptatrienyl (C₇), cyclooctyl (C₈), cyclooctenyl (C₈), bicyclo[2.2.1]heptanyl (C₇), bicyclo[2.2.2]octanyl (C₈), and the like. Exemplary C₃₋₁₀ carbocyclyl groups include the aforementioned C₃₋₈ carbocyclyl groups as well as cyclononyl (C₉), cyclononenyl (C₉), cyclodecyl (C₁₀), cyclodecenyl (C₁₀), octahydro-1H-indenyl (C₉), decahydronaphthalenyl (C₁₀), spiro[4.5]decanyl (C₁₀), and the like. As the foregoing examples illustrate, in certain embodiments, the carbocyclyl group is either monocyclic (“monocyclic carbocyclyl”) or polycyclic (e.g., containing a fused, bridged or spiro ring system such as a bicyclic system (“bicyclic carbocyclyl”) or tricyclic system (“tricyclic carbocyclyl”)) and can be saturated or can contain one or more carbon-carbon double or triple bonds. “Carbocyclyl” also includes ring systems wherein the carbocyclyl ring, as defined above, is fused with one or more aryl or heteroaryl groups wherein the point of attachment is on the carbocyclyl ring, and in such instances, the number of carbons continue to designate the number of carbons in the carbocyclic ring system. Unless otherwise specified, each instance of a carbocyclyl group is independently unsubstituted (an “unsubstituted carbocyclyl”) or substituted (a “substituted carbocyclyl”) with one or more substituents. In certain embodiments, the carbocyclyl group is an unsubstituted C₃₋₁₄ carbocyclyl. In certain embodiments, the carbocyclyl group is a substituted C₃₋₁₄ carbocyclyl. In certain embodiments, the carbocyclyl is substituted or unsubstituted, 3- to 8-membered, and monocyclic. In certain embodiments, the carbocyclyl is substituted or unsubstituted, 5- to 14-membered, and bicyclic. In certain embodiments, the carbocyclyl is substituted or unsubstituted, 6- to 14-membered, and tricyclic.

In some embodiments, “carbocyclyl” is a monocyclic, saturated carbocyclyl group having from 3 to 14 ring carbon atoms (“C₃₋₁₄ cycloalkyl”). In some embodiments, a cycloalkyl group has 3 to 10 ring carbon atoms (“C₃₋₁₀ cycloalkyl”). In some embodiments, a cycloalkyl group has 3 to 8 ring carbon atoms (“C₃₋₈ cycloalkyl”). In some embodiments, a cycloalkyl group has 3 to 6 ring carbon atoms (“C₃₋₆ cycloalkyl”). In some embodiments, a cycloalkyl group has 4 to 6 ring carbon atoms (“C₄₋₆ cycloalkyl”). In some embodiments, a cycloalkyl group has 5 to 6 ring carbon atoms (“C₅₋₆ cycloalkyl”). In some embodiments, a cycloalkyl group has 5 to 10 ring carbon atoms (“C₅₋₁₀ cycloalkyl”). Examples of C₅₋₆ cycloalkyl groups include cyclopentyl (C₅) and cyclohexyl (C₅). Examples of C₃₋₆ cycloalkyl groups include the aforementioned C₅₋₆ cycloalkyl groups as well as cyclopropyl (C₃) and cyclobutyl (C₄). Examples of C₃₋₈ cycloalkyl groups include the aforementioned C₃₋₆ cycloalkyl groups as well as cycloheptyl (C₇) and cyclooctyl (C₈). Unless otherwise specified, each instance of a cycloalkyl group is independently unsubstituted (an “unsubstituted cycloalkyl”) or substituted (a “substituted cycloalkyl”) with one or more substituents. In certain embodiments, the cycloalkyl group is an unsubstituted C₃₋₁₄ cycloalkyl. In certain embodiments, the cycloalkyl group is a substituted C₃₋₁₄ cycloalkyl. In certain embodiments, the carbocyclyl includes 0, 1, or 2 C═C double bonds in the carbocyclic ring system, as valency permits.

The term “heterocyclyl” or “heterocyclic” refers to a radical of a 3- to 14-membered non-aromatic ring system having ring carbon atoms and 1 to 4 ring heteroatoms, wherein each heteroatom is independently selected from nitrogen, oxygen, and sulfur (“3-14 membered heterocyclyl”). In heterocyclyl groups that contain one or more nitrogen atoms, the point of attachment can be a carbon or nitrogen atom, as valency permits. A heterocyclyl group can either be monocyclic (“monocyclic heterocyclyl”) or polycyclic (e.g., a fused, bridged or spiro ring system such as a bicyclic system (“bicyclic heterocyclyl”) or tricyclic system (“tricyclic heterocyclyl”)), and can be saturated or can contain one or more carbon-carbon double or triple bonds. Heterocyclyl polycyclic ring systems can include one or more heteroatoms in one or both rings. “Heterocyclyl” also includes ring systems wherein the heterocyclyl ring, as defined above, is fused with one or more carbocyclyl groups wherein the point of attachment is either on the carbocyclyl or heterocyclyl ring, or ring systems wherein the heterocyclyl ring, as defined above, is fused with one or more aryl or heteroaryl groups, wherein the point of attachment is on the heterocyclyl ring, and in such instances, the number of ring members continues to designate the number of ring members in the heterocyclyl ring system. Unless otherwise specified, each instance of heterocyclyl is independently unsubstituted (an “unsubstituted heterocyclyl”) or substituted (a “substituted heterocyclyl”) with one or more substituents. In certain embodiments, the heterocyclyl group is an unsubstituted 3-14 membered heterocyclyl. In certain embodiments, the heterocyclyl group is a substituted 3-14 membered heterocyclyl. In certain embodiments, the heterocyclyl is substituted or unsubstituted, 3- to 8-membered, monocyclic heterocyclyl, wherein 1, 2, or 3 atoms in the heterocyclic ring system are independently oxygen, nitrogen, or sulfur, as valency permits. In certain embodiments, the heterocyclyl is substituted or unsubstituted, 5- to 14-membered, bicyclic heterocyclyl, wherein 1, 2, 3, or 4 atoms in the heterocyclic ring system are independently oxygen, nitrogen, or sulfur, as valency permits. In certain embodiments, the heterocyclyl is substituted or unsubstituted, 6- to 14-membered, tricyclic heterocyclyl, wherein 1, 2, 3, or 4 atoms in the heterocyclic ring system are independently oxygen, nitrogen, or sulfur, as valency permits.

In some embodiments, a heterocyclyl group is a 5-10 membered non-aromatic ring system having ring carbon atoms and 1-4 ring heteroatoms, wherein each heteroatom is independently selected from nitrogen, oxygen, and sulfur (“5-10 membered heterocyclyl”). In some embodiments, a heterocyclyl group is a 5-8 membered non-aromatic ring system having ring carbon atoms and 1-4 ring heteroatoms, wherein each heteroatom is independently selected from nitrogen, oxygen, and sulfur (“5-8 membered heterocyclyl”). In some embodiments, a heterocyclyl group is a 5-6 membered non-aromatic ring system having ring carbon atoms and 1-4 ring heteroatoms, wherein each heteroatom is independently selected from nitrogen, oxygen, and sulfur (“5-6 membered heterocyclyl”). In some embodiments, the 5-6 membered heterocyclyl has 1-3 ring heteroatoms selected from nitrogen, oxygen, and sulfur. In some embodiments, the 5-6 membered heterocyclyl has 1-2 ring heteroatoms selected from nitrogen, oxygen, and sulfur. In some embodiments, the 5-6 membered heterocyclyl has 1 ring heteroatom selected from nitrogen, oxygen, and sulfur.

Exemplary 3-membered heterocyclyl groups containing 1 heteroatom include aziridinyl, oxiranyl, and thiiranyl. Exemplary 4-membered heterocyclyl groups containing 1 heteroatom include azetidinyl, oxetanyl, and thietanyl. Exemplary 5-membered heterocyclyl groups containing 1 heteroatom include tetrahydrofuranyl, dihydrofuranyl, tetrahydrothiophenyl, dihydrothiophenyl, pyrrolidinyl, dihydropyrrolyl, and pyrrolyl-2,5-dione. Exemplary 5-membered heterocyclyl groups containing 2 heteroatoms include dioxolanyl, oxathiolanyl and dithiolanyl. Exemplary 5-membered heterocyclyl groups containing 3 heteroatoms include triazolinyl, oxadiazolinyl, and thiadiazolinyl. Exemplary 6-membered heterocyclyl groups containing 1 heteroatom include piperidinyl, tetrahydropyranyl, dihydropyridinyl, and thianyl. Exemplary 6-membered heterocyclyl groups containing 2 heteroatoms include piperazinyl, morpholinyl, dithianyl, and dioxanyl. Exemplary 6-membered heterocyclyl groups containing 3 heteroatoms include triazinyl. Exemplary 7-membered heterocyclyl groups containing 1 heteroatom include azepanyl, oxepanyl and thiepanyl. Exemplary 8-membered heterocyclyl groups containing 1 heteroatom include azocanyl, oxecanyl and thiocanyl. Exemplary bicyclic heterocyclyl groups include indolinyl, isoindolinyl, dihydrobenzofuranyl, dihydrobenzothienyl, tetrahydrobenzothienyl, tetrahydrobenzofuranyl, tetrahydroindolyl, tetrahydroquinolinyl, tetrahydroisoquinolinyl, decahydroquinolinyl, decahydroisoquinolinyl, octahydrochromenyl, octahydroisochromenyl, decahydronaphthyridinyl, decahydro-1,8-naphthyridinyl, octahydropyrrolo[3,2-b]pyrrole, indolinyl, phthalimidyl, naphthalimidyl, chromanyl, chromenyl, 1H-benzo[e][1,4]diazepinyl, 1,4,5,7-tetrahydropyrano[3,4-b]pyrrolyl, 5,6-dihydro-4H-furo[3,2-b]pyrrolyl, 6,7-dihydro-5H-furo[3,2-b]pyranyl, 5,7-dihydro-4H-thieno[2,3-c]pyranyl, 2,3-dihydro-1H-pyrrolo[2,3-b]pyridinyl, 2,3-dihydrofuro[2,3-b]pyridinyl, 4,5,6,7-tetrahydro-TH-pyrrolo[2,3-b]pyridinyl, 4,5,6,7-tetrahydrofuro[3,2-c]pyridinyl, 4,5,6,7-tetrahydrothieno[3,2-b]pyridinyl, 1,2,3,4-tetrahydro-1,6-naphthyridinyl, and the like.

The term “aryl” refers to a radical of a monocyclic or polycyclic (e.g., bicyclic or tricyclic) 4n+2 aromatic ring system (e.g., having 6, 10, or 14 π electrons shared in a cyclic array) having 6-14 ring carbon atoms and zero heteroatoms provided in the aromatic ring system (“C₆₋₁₄ aryl”). In some embodiments, an aryl group has 6 ring carbon atoms (“C₆ aryl”; e.g., phenyl). In some embodiments, an aryl group has 10 ring carbon atoms (“C₁₀ aryl”; e.g., naphthyl such as 1-naphthyl and 2-naphthyl). In some embodiments, an aryl group has 14 ring carbon atoms (“C₁₄ aryl”; e.g., anthracyl). “Aryl” also includes ring systems wherein the aryl ring, as defined above, is fused with one or more carbocyclyl or heterocyclyl groups wherein the radical or point of attachment is on the aryl ring, and in such instances, the number of carbon atoms continue to designate the number of carbon atoms in the aryl ring system. Unless otherwise specified, each instance of an aryl group is independently unsubstituted (an “unsubstituted aryl,” e.g., unsubstituted phenyl (“Ph”)) or substituted (a “substituted aryl”) with one or more substituents. In certain embodiments, the aryl group is an unsubstituted C₆₋₁₄ aryl. In certain embodiments, the aryl group is a substituted C₆₋₁₄ aryl.

“Aralkyl” is a subset of “alkyl” and refers to an alkyl group substituted by an aryl group, wherein the point of attachment is on the alkyl moiety.

The term “heteroaryl” refers to a radical of a 5-14 membered monocyclic or polycyclic (e.g., bicyclic, tricyclic) 4n+2 aromatic ring system (e.g., having 6, 10, or 14 π electrons shared in a cyclic array) having ring carbon atoms and 1-4 ring heteroatoms provided in the aromatic ring system, wherein each heteroatom is independently selected from nitrogen, oxygen, and sulfur (“5-14 membered heteroaryl”). In heteroaryl groups that contain one or more nitrogen atoms, the point of attachment can be a carbon or nitrogen atom, as valency permits. Heteroaryl polycyclic ring systems can include one or more heteroatoms in one or both rings. “Heteroaryl” includes ring systems wherein the heteroaryl ring, as defined above, is fused with one or more carbocyclyl or heterocyclyl groups wherein the point of attachment is on the heteroaryl ring, and in such instances, the number of ring members continues to designate the number of ring members in the heteroaryl ring system. “Heteroaryl” also includes ring systems wherein the heteroaryl ring, as defined above, is fused with one or more aryl groups wherein the point of attachment is either on the aryl or heteroaryl ring, and in such instances, the number of ring members designates the number of ring members in the fused polycyclic (aryl/heteroaryl) ring system. Polycyclic heteroaryl groups wherein one ring does not contain a heteroatom (e.g., indolyl, quinolinyl, carbazolyl, and the like) the point of attachment can be on either ring, i.e., either the ring bearing a heteroatom (e.g., 2-indolyl) or the ring that does not contain a heteroatom (e.g., 5-indolyl). In certain embodiments, the heteroaryl is substituted or unsubstituted, 5- or 6-membered, monocyclic heteroaryl, wherein 1, 2, 3, or 4 atoms in the heteroaryl ring system are independently oxygen, nitrogen, or sulfur. In certain embodiments, the heteroaryl is substituted or unsubstituted, 9- or 10-membered, bicyclic heteroaryl, wherein 1, 2, 3, or 4 atoms in the heteroaryl ring system are independently oxygen, nitrogen, or sulfur.

In some embodiments, a heteroaryl group is a 5-10 membered aromatic ring system having ring carbon atoms and 1-4 ring heteroatoms provided in the aromatic ring system, wherein each heteroatom is independently selected from nitrogen, oxygen, and sulfur (“5-10 membered heteroaryl”). In some embodiments, a heteroaryl group is a 5-8 membered aromatic ring system having ring carbon atoms and 1-4 ring heteroatoms provided in the aromatic ring system, wherein each heteroatom is independently selected from nitrogen, oxygen, and sulfur (“5-8 membered heteroaryl”). In some embodiments, a heteroaryl group is a 5-6 membered aromatic ring system having ring carbon atoms and 1-4 ring heteroatoms provided in the aromatic ring system, wherein each heteroatom is independently selected from nitrogen, oxygen, and sulfur (“5-6 membered heteroaryl”). In some embodiments, the 5-6 membered heteroaryl has 1-3 ring heteroatoms selected from nitrogen, oxygen, and sulfur. In some embodiments, the 5-6 membered heteroaryl has 1-2 ring heteroatoms selected from nitrogen, oxygen, and sulfur. In some embodiments, the 5-6 membered heteroaryl has 1 ring heteroatom selected from nitrogen, oxygen, and sulfur. Unless otherwise specified, each instance of a heteroaryl group is independently unsubstituted (an “unsubstituted heteroaryl”) or substituted (a “substituted heteroaryl”) with one or more substituents. In certain embodiments, the heteroaryl group is an unsubstituted 5-14 membered heteroaryl. In certain embodiments, the heteroaryl group is a substituted 5-14 membered heteroaryl.

Exemplary 5-membered heteroaryl groups containing 1 heteroatom include pyrrolyl, furanyl, and thiophenyl. Exemplary 5-membered heteroaryl groups containing 2 heteroatoms include imidazolyl, pyrazolyl, oxazolyl, isoxazolyl, thiazolyl, and isothiazolyl. Exemplary 5-membered heteroaryl groups containing 3 heteroatoms include triazolyl, oxadiazolyl, and thiadiazolyl. Exemplary 5-membered heteroaryl groups containing 4 heteroatoms include tetrazolyl. Exemplary 6-membered heteroaryl groups containing 1 heteroatom include pyridinyl. Exemplary 6-membered heteroaryl groups containing 2 heteroatoms include pyridazinyl, pyrimidinyl, and pyrazinyl. Exemplary 6-membered heteroaryl groups containing 3 or 4 heteroatoms include triazinyl and tetrazinyl, respectively. Exemplary 7-membered heteroaryl groups containing 1 heteroatom include azepinyl, oxepinyl, and thiepinyl. Exemplary 5,6-bicyclic heteroaryl groups include indolyl, isoindolyl, indazolyl, benzotriazolyl, benzothiophenyl, isobenzothiophenyl, benzofuranyl, benzoisofuranyl, benzimidazolyl, benzoxazolyl, benzisoxazolyl, benzoxadiazolyl, benzthiazolyl, benzisothiazolyl, benzthiadiazolyl, indolizinyl, and purinyl. Exemplary 6,6-bicyclic heteroaryl groups include naphthyridinyl, pteridinyl, quinolinyl, isoquinolinyl, cinnolinyl, quinoxalinyl, phthalazinyl, and quinazolinyl. Exemplary tricyclic heteroaryl groups include phenanthridinyl, dibenzofuranyl, carbazolyl, acridinyl, phenothiazinyl, phenoxazinyl and phenazinyl.

“Heteroaralkyl” is a subset of “alkyl” and refers to an alkyl group substituted by a heteroaryl group, wherein the point of attachment is on the alkyl moiety.

The term “unsaturated bond” refers to a double or triple bond.

The term “unsaturated” or “partially unsaturated” refers to a moiety that includes at least one double or triple bond.

The term “saturated” or “fully saturated” refers to a moiety that does not contain a double or triple bond, i.e., the moiety only contains single bonds.

Affixing the suffix “-ene” to a group indicates the group is a divalent moiety, e.g., alkylene is the divalent moiety of alkyl, alkenylene is the divalent moiety of alkenyl, alkynylene is the divalent moiety of alkynyl, heteroalkylene is the divalent moiety of heteroalkyl, heteroalkenylene is the divalent moiety of heteroalkenyl, heteroalkynylene is the divalent moiety of heteroalkynyl, carbocyclylene is the divalent moiety of carbocyclyl, heterocyclylene is the divalent moiety of heterocyclyl, arylene is the divalent moiety of aryl, and heteroarylene is the divalent moiety of heteroaryl.

A group is optionally substituted unless expressly provided otherwise. The term “optionally substituted” refers to being substituted or unsubstituted. In certain embodiments, alkyl, alkenyl, alkynyl, heteroalkyl, heteroalkenyl, heteroalkynyl, carbocyclyl, heterocyclyl, aryl, and heteroaryl groups are optionally substituted. “Optionally substituted” refers to a group which may be substituted or unsubstituted (e.g., “substituted” or “unsubstituted” alkyl, “substituted” or “unsubstituted” alkenyl, “substituted” or “unsubstituted” alkynyl, “substituted” or “unsubstituted” heteroalkyl, “substituted” or “unsubstituted” heteroalkenyl, “substituted” or “unsubstituted” heteroalkynyl, “substituted” or “unsubstituted” carbocyclyl, “substituted” or “unsubstituted” heterocyclyl, “substituted” or “unsubstituted” aryl or “substituted” or “unsubstituted” heteroaryl group). In general, the term “substituted” means that at least one hydrogen present on a group is replaced with a permissible substituent, e.g., a substituent which upon substitution results in a stable compound, e.g., a compound which does not spontaneously undergo transformation such as by rearrangement, cyclization, elimination, or other reaction. Unless otherwise indicated, a “substituted” group has a substituent at one or more substitutable positions of the group, and when more than one position in any given structure is substituted, the substituent is either the same or different at each position. The term “substituted” is contemplated to include substitution with all permissible substituents of organic compounds, and includes any of the substituents described herein that results in the formation of a stable compound. The present invention contemplates any and all such combinations in order to arrive at a stable compound. For purposes of this invention, heteroatoms such as nitrogen may have hydrogen substituents and/or any suitable substituent as described herein which satisfy the valencies of the heteroatoms and results in the formation of a stable moiety. The invention is not intended to be limited in any manner by the exemplary substituents described herein.

In certain embodiments, each carbon atom of a moiety described herein is independently unsubstituted or substituted as valency permits (e.g., at valency 4). A substituent on a carbon atom is a “carbon atom substituent.”

In certain embodiments, each nitrogen atom of a moiety described herein is independently unsubstituted or substituted as valency permits (e.g., at valency 3 or 5). A substituent on a nitrogen atom is a “nitrogen atom substituent.”

In certain embodiments, each oxygen atom of a moiety described herein is independently unsubstituted or substituted as valency permits (e.g., at valency 2). A substituent on an oxygen atom is a “oxygen atom substituent.”

In certain embodiments, each sulfur atom of a moiety described herein is independently unsubstituted or substituted as valency permits (e.g., at valency 2, 4, or 6). A substituent on a sulfur atom is a “sulfur atom substituent.”

In certain embodiments, each carbon atom substituent is independently selected from the group consisting of halogen, —CN, —NO₂, —N₃, —SO₂H, —SO₃H, —OH, —OR^{aa}, —ON(R^{bb})₂, —N(R^{bb})₂, —N(R^{bb})₃⁺X⁻, —N(OR^{cc})R^{bb}, —SH, —SR^{aa}, —SSR^{cc}, —C(═O)R^{aa}, —CO₂H, —CHO, —C(OR^{cc})₂, —CO₂R^{aa}, —OC(═O)R^{aa}, —OCO₂R^{aa}, —C(═O)N(R^{bb})₂, —OC(═O)N(R^{bb})₂, —NR^{bb}C(═O)R^{aa}, —NR^{bb}CO₂R^{aa}, —NR^{bb}C(═O)N(R^{bb})₂, —C(═NR^{bb})R^{aa}, —C(═NR^{bb})OR^{aa}, —OC(═NR^{bb})R^{aa}, —OC(═NR^{bb})OR^{aa}, —C(═NR^{bb})N(R^{bb})₂, —OC(═NR^{bb})N(R^{bb})₂, —NR^{bb}C(═NR^{bb})N(R^{bb})₂, —C(═O)NR^{bb}SO₂R^{aa}, —NR^{bb}SO₂R^{aa}, —SO₂N(R^{bb})₂, —SO₂R^{aa}, —SO₂OR^{aa}, —OSO₂R^{aa}, —S(═O)R^{aa}, —OS(═O)R^{aa}, —Si(R^{aa})₃, —OSi(R^{aa})₃, —C(═S)N(R^{bb})₂, —C(═O)SR^{aa}, —C(═S)SR^{aa}, —SC(═S)SR^{aa}, —SC(═O)SR^{aa}, —OC(═O)SR^{aa}, —SC(═O)OR^{aa}, —SC(═O)R^{aa}, —P(═O)₂R^{aa}, —OP(═O)₂R^{aa}, —P(═O)(R^{aa})₂, —OP(═O)(R^{aa})₂, —OP(═O)(OR^{cc})₂, —P(═O)₂N(R^{bb})₂, —OP(═O)₂N(R^{bb})₂, —P(═O)(NR^{bb})₂, —OP(═O)(NR^{bb})₂, —NR^{bb}P(═O)(OR^{cc})₂, —NR^{bb}P(═O)(NR^{bb})₂, —P(R^{cc})₂, —P(R^{cc})₃, —OP(R^{cc})₂, —OP(R^{cc})₃, —B(R^{aa})₂, —B(OR^{cc})₂, —BR^{aa}(OR^{cc}), C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, 5-14 membered heteroaryl, ═O, ═S, ═NN(R^{bb})₂, ═NNR^{bb}C(═O)R^{aa}, ═NNR^{bb}C(═O)OR^{aa}, ═NNR^{bb}S(═O)₂R^{aa}, ═NR^{bb}, and ═NOR^{cc}, wherein each of the alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd}.

Each instance of R^{aa} is independently selected from the group consisting of C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, or two R^{aa} are joined to form 3-14 membered heterocyclyl or 5-14 membered heteroaryl, wherein each of the alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd}.
each instance of R^{bb} is independently selected from the group consisting of hydrogen, —OH, —OR^{aa}, —N(R^{cc})₂, —CN, —C(═O)R^{aa}, —C(═O)N(R^{cc})₂, —CO₂R^{aa}, —SO₂R^{aa}, —C(═NR^{cc})OR^{aa}, —C(═NR^{cc})N(R^{cc})₂, —SO₂N(R^{cc})₂, —SO₂R^{cc}, —SO₂OR^{cc}, —SOR^{aa}, —C(═S)N(R^{cc})₂, —C(═O)SR^{cc}, —C(═S)SR^{cc}, —P(═O)₂R^{aa}, —P(═O)(R^{aa})₂, —P(═O)₂N(R^{cc})₂, —P(═O)(NR^{cc})₂, C₁₋₁₀ alkyl, C₁₋₁₀ perhaloalkyl, C₂₋₁₀ alkenyl, C₂₋₁₀ alkynyl, heteroC₁₋₁₀alkyl, heteroC₂₋₁₀alkenyl, heteroC₂₋₁₀ alkynyl, C₃₋₁₀ carbocyclyl, 3-14 membered heterocyclyl, C₆₋₁₄ aryl, and 5-14 membered heteroaryl, or two R^{bb} are joined to form 3-14 membered heterocyclyl or 5-14 membered heteroaryl, wherein each of the alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd}.
each instance of R^{cc} is independently selected from the group consisting of hydrogen, C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, or two R^{cc} are joined to form 3-14 membered heterocyclyl or 5-14 membered heteroaryl, wherein each of the alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd};
each instance of R^{dd} is independently selected from the group consisting of halogen, —CN, —NO₂, —N₃, —SO₂H, —SO₃H, —OH, —OR^{ee}, —ON(R^{ff})₂, —N(R^{ff})₂, —N(R^{ff})₃⁺X⁻, —N(OR^{ee})R^{ff}, —SH, —SR^{ee}, —SSR^{ee}, —C(═O)R^{ee}, —CO₂H, —CO₂R^{ee}, —OC(═O)R^{ee}, —OCO₂R^{ee}, —C(═O)N(R^{ff})₂, —OC(═O)N(R^{ff})₂, —N^{ff}C(═O)R^{ee}, —NR^{ff}CO₂R^{ee}, —NR^{ff}C(═O)N(R^{ff})₂, —C(═NR^{ff})OR^{ee}, —OC(═NR^{ff})R^{ee}, —OC(═NR^{ff})OR^{ee}, —C(═NR^{ff})N(R^{ff})₂, —OC(═NR^{ff})N(R^{ff})₂, —NR^{ff}C(═NR^{ff})N(R^{ff})₂, —NR^{ff}SO₂R^{ee}, —SO₂N(R^{ff})₂, —SO₂R^{ee}, —SO₂OR^{ee}, —OSO₂R^{ee}, —S(═O)R^{ee}, —Si(R^{ee})₃, —OSi(R^{ee})₃, —C(═S)N(R^{ff})₂, —C(═O)SR^{ee}, —C(═S)SR^{ee}, —SC(═S)SR^{ee}, —P(═O)₂R^{ee}, —P(═O)(R^{ee})₂, —OP(═O)(R^{ee})₂, —OP(═O)(OR^{ee})₂, C₁₋₆ alkyl, C₁₋₆ perhaloalkyl, C₂₋₆ alkenyl, C₂₋₆ alkynyl, heteroC₁₋₆alkyl, heteroC₂₋₆alkenyl, heteroC₂₋₆alkynyl, C₃₋₁₀ carbocyclyl, 3-10 membered heterocyclyl, C₆₋₁₀ aryl, 5-10 membered heteroaryl, ═O, and ═S, wherein each of the alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{gg};
each instance of R^{ee} is independently selected from the group consisting of C₁₋₆ alkyl, C₁₋₆ perhaloalkyl, C₂₋₆ alkenyl, C₂₋₆ alkynyl, heteroC₁₋₆ alkyl, heteroC₂₋₆alkenyl, heteroC₂₋₆ alkynyl, C₃₋₁₀ carbocyclyl, C₆₋₁₀ aryl, 3-10 membered heterocyclyl, and 3-10 membered heteroaryl, wherein each of the alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{gg};
each instance of R^{ff} is independently selected from the group consisting of hydrogen, C₁₋₆ alkyl, C₁₋₆ perhaloalkyl, C₂₋₆ alkenyl, C₂₋₆ alkynyl, heteroC₁₋₆alkyl, heteroC₂₋₆alkenyl, heteroC₂₋₆ alkynyl, C₃₋₁₀ carbocyclyl, 3-10 membered heterocyclyl, C₆₋₁₀ aryl, and 5-10 membered heteroaryl, or two R^{ff} are joined to form 3-10 membered heterocyclyl or 5-10 membered heteroaryl, wherein each of the alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{gg};
each instance of R^{gg} is independently selected from the group consisting of halogen, —CN, —NO₂, —N₃, —SO₂H, —SO₃H, —OH, —OC₁₋₆ alkyl, —ON(C₁₋₆ alkyl)₂, —N(C₁₋₆ alkyl)₂, —N(C₁₋₆ alkyl)₃⁺X⁻, —NH(C₁₋₆ alkyl)₂⁺X⁻, —NH₂(C₁₋₆ alkyl)⁺X⁻, —NH₃⁺X⁻, —N(OC₁₋₆ alkyl)(C₁₋₆ alkyl), —N(OH)(C₁₋₆ alkyl), —NH(OH), —SH, —SC₁₋₆ alkyl, —SS(C₁₋₆ alkyl), —C(═O)(C₁₋₆ alkyl), —CO₂H, —CO₂(C₁₋₆ alkyl), —OC(═O)(C₁₋₆ alkyl), —OCO₂(C₁₋₆ alkyl), —C(═O)NH₂, —C(═O)N(C₁₋₆ alkyl)₂, —OC(═O)NH(C₁₋₆ alkyl), —NHC(═O)(C₁₋₆ alkyl), —N(C₁₋₆ alkyl)C(═O)(C₁₋₆ alkyl), —NHCO₂(C₁₋₆ alkyl), —NHC(═O)N(C₁₋₆ alkyl)₂, —NHC(═O)NH(C₁₋₆ alkyl), —NHC(═O)NH₂, —C(═NH)O(C₁₋₆ alkyl), —OC(═NH)(C₁₋₆ alkyl), —OC(═NH)OC₁₋₆ alkyl, —C(═NH)N(C₁₋₆ alkyl)₂, —C(═NH)NH(C₁₋₆ alkyl), —C(═NH)NH₂, —OC(═NH)N(C₁₋₆ alkyl)₂, —OC(NH)NH(C₁₋₆ alkyl), —OC(NH)NH₂, —NHC(NH)N(C₁₋₆ alkyl)₂, —NHC(═NH)NH₂, —NHSO₂(C₁₋₆ alkyl), —SO₂N(C₁₋₆ alkyl)₂, —SO₂NH(C₁₋₆ alkyl), —SO₂NH₂, —SO₂C₁₋₆ alkyl, —SO₂OC₁₋₆ alkyl, —OSO₂C₁₋₆ alkyl, —SOC₁₋₆ alkyl, —Si(C₁₋₆ alkyl)₃, —OSi(C₁₋₆ alkyl)₃ —C(═S)N(C₁₋₆ alkyl)₂, C(═S)NH(C₁₋₆ alkyl), C(═S)NH₂, —C(═O)S(C₁₋₆ alkyl), —C(═S)SC₁₋₆ alkyl, —SC(═S)SC₁₋₆ alkyl, —P(═O)₂(C₁₋₆ alkyl), —P(═O)(C₁₋₆ alkyl)₂, —OP(═O)(C₁₋₆ alkyl)₂, —OP(═O)(OC₁₋₆ alkyl)₂, C₁₋₆ alkyl, C₁₋₆ perhaloalkyl, C₂₋₆ alkenyl, C₂₋₆ alkynyl, heteroC₁₋₆alkyl, heteroC₂₋₆alkenyl, heteroC₂₋₆alkynyl, C₃₋₁₀ carbocyclyl, C₆₋₁₀ aryl, 3-10 membered heterocyclyl, 5-10 membered heteroaryl, ═O, and ═S; and
X⁻ is a counterion.

In certain embodiments, the carbon atom substituents are independently halogen, substituted (e.g., substituted with one or more halogen) or unsubstituted C₁₋₆ alkyl, —OR^{aa}, —SR^{aa}, —N(R^{bb})₂, —CN, —SCN, —NO₂, —C(═O)R^{aa}, —CO₂R^{aa}, —C(═O)N(R^{bb})₂, —OC(═O)R^{aa}, —OCO₂R^{aa}, —OC(═O)N(R^{bb})₂, —NR^{bb}C(═O)R^{aa}, —NR^{bb}CO₂R^{aa}, or —NR^{bb}C(═O)N(R^{bb})₂. In certain embodiments, the carbon atom substituents are independently halogen, substituted (e.g., substituted with one or more halogen) or unsubstituted C₁₋₆ alkyl, —OR^{aa}, —SR^{aa}, —N(R^{bb})₂, —CN, —SCN, —NO₂, —C(═O)R^{aa}, —CO₂R^{aa}, —C(═O)N(R^{bb})₂, —OC(═O)R^{aa}, —OCO₂R^{aa}, —OC(═O)N(R^{bb})₂, —NR^{bb}C(═O)R^{aa}, —NR^{bb}CO₂R^{aa}, or —NR^{bb}C(═O)N(R^{bb})₂, wherein R^{aa} is hydrogen, substituted (e.g., substituted with one or more halogen) or unsubstituted C₁₋₆ alkyl, an oxygen protecting group (e.g., silyl, TBDPS, TBDMS, TIPS, TES, TMS, MOM, THP, t-Bu, Bn, allyl, acetyl, pivaloyl, or benzoyl) when attached to an oxygen atom, or a sulfur protecting group (e.g., acetamidomethyl, t-Bu, 3-nitro-2-pyridine sulfenyl, 2-pyridine-sulfenyl, or triphenylmethyl) when attached to a sulfur atom; and each R^{bb} is independently hydrogen, substituted (e.g., substituted with one or more halogen) or unsubstituted C₁₋₆ alkyl, or a nitrogen protecting group (e.g., Bn, Boc, Cbz, Fmoc, trifluoroacetyl, triphenylmethyl, acetyl, or Ts). In certain embodiments, the carbon atom substituents are independently halogen, substituted (e.g., substituted with one or more halogen) or unsubstituted C₁₋₆ alkyl, —OR^{aa}, —SR^{aa}, —N(R^{bb})₂, —CN, —SCN, or —NO₂. In certain embodiments, the carbon atom substituents are independently halogen, substituted (e.g., substituted with one or more halogen moieties) or unsubstituted C₁₋₆ alkyl, —OR^{aa}, —SR^{aa}, —N(R^{bb})₂, —CN, —SCN, or —NO₂, wherein R^{aa} is hydrogen, substituted (e.g., substituted with one or more halogen) or unsubstituted C₁₋₆ alkyl, an oxygen protecting group (e.g., silyl, TBDPS, TBDMS, TIPS, TES, TMS, MOM, THP, t-Bu, Bn, allyl, acetyl, pivaloyl, or benzoyl) when attached to an oxygen atom, or a sulfur protecting group (e.g., acetamidomethyl, t-Bu, 3-nitro-2-pyridine sulfenyl, 2-pyridine-sulfenyl, or triphenylmethyl) when attached to a sulfur atom; and each R^{bb} is independently hydrogen, substituted (e.g., substituted with one or more halogen) or unsubstituted C₁₋₆ alkyl, or a nitrogen protecting group (e.g., Bn, Boc, Cbz, Fmoc, trifluoroacetyl, triphenylmethyl, acetyl, or Ts).

In certain embodiments, the molecular weight of a carbon atom substituent is lower than 250, lower than 200, lower than 150, lower than 100, or lower than 50 g/mol. In certain embodiments, a carbon atom substituent consists of carbon, hydrogen, fluorine, chlorine, bromine, iodine, oxygen, sulfur, nitrogen, and/or silicon atoms. In certain embodiments, a carbon atom substituent consists of carbon, hydrogen, fluorine, chlorine, bromine, iodine, oxygen, sulfur, and/or nitrogen atoms. In certain embodiments, a carbon atom substituent consists of carbon, hydrogen, fluorine, chlorine, bromine, and/or iodine atoms. In certain embodiments, a carbon atom substituent consists of carbon, hydrogen, fluorine, and/or chlorine atoms.

The term “halo” or “halogen” refers to fluorine (fluoro, —F), chlorine (chloro, —Cl), bromine (bromo, —Br), or iodine (iodo, —I).

The term “hydroxyl” or “hydroxy” refers to the group —OH. The term “substituted hydroxyl” or “substituted hydroxyl,” by extension, refers to a hydroxyl group wherein the oxygen atom directly attached to the parent molecule is substituted with a group other than hydrogen, and includes groups selected from —OR^{aa}, —ON(R^{bb})₂, —OC(═O)SR^{aa}, —OC(═O)R^{aa}, —OCO₂R^{aa}, —OC(═O)N(R^{bb})₂, —OC(═NR^{bb})R^{aa}, —OC(═NR^{bb})OR^{aa}, —OC(═NR^{bb})N(R^{bb})₂, —OS(═O)R^{aa}, —OSO₂R^{aa}, —OSi(R^{aa})₃, —OP(R^{cc})₂, —OP(R^{cc})₃, —OP(═O)₂R^{aa}, —OP(═O)(R^{aa})₂, —OP(═O)(OR^{cc})₂, —OP(═O)₂N(R^{bb})₂, and —OP(═O)(NR^{bb})₂, wherein R^{aa}, R^{bb}, and R^{cc} are as defined herein.

The term “thiol” or “thio” refers to the group —SH. The term “substituted thiol” or “substituted thio,” by extension, refers to a thiol group wherein the sulfur atom directly attached to the parent molecule is substituted with a group other than hydrogen, and includes groups selected from —SR^{aa}, —S═SR^{cc}, —SC(═S)SR^{aa}, —SC(═O)SR^{aa}, —SC(═O)OR^{aa}, and —SC(═O)R^{aa}, wherein R^{aa} and R^{cc} are as defined herein.

The term “amino” refers to the group —NH₂. The term “substituted amino,” by extension, refers to a monosubstituted amino, a disubstituted amino, or a trisubstituted amino. In certain embodiments, the “substituted amino” is a monosubstituted amino or a disubstituted amino group.

The term “monosubstituted amino” refers to an amino group wherein the nitrogen atom directly attached to the parent molecule is substituted with one hydrogen and one group other than hydrogen, and includes groups selected from —NH(R^{bb}), —NHC(═O)R^{aa}, —NHCO₂R^{aa}, —NHC(═O)N(R^{bb})₂, —NHC(═NR^{bb})N(R^{bb})₂, —NHSO₂R^{aa}, —NHP(═O)(OR^{cc})₂, and —NHP(═O)(NR^{bb})₂, wherein R^{aa}, R^{bb} and R^{cc} are as defined herein, and wherein R^{bb} of the group —NH(R^{bb}) is not hydrogen.

The term “disubstituted amino” refers to an amino group wherein the nitrogen atom directly attached to the parent molecule is substituted with two groups other than hydrogen, and includes groups selected from —N(R^{bb})₂, —NR^{bb} C(═O)R^{aa}, —NR^{bb}CO₂R^{aa}, —NR^{bb}C(═O)N(R^{bb})₂, —NR^{bb}C(═NR^{bb})N(R^{bb})₂, —NR^{bb}SO₂R^{aa}, —NR^{bb}(═O)(OR^{cc})₂, and —NR^{bb}P(═O)(NR^{bb})₂, wherein R^{aa}, R^{bb}, and R^{cc} are as defined herein, with the proviso that the nitrogen atom directly attached to the parent molecule is not substituted with hydrogen.

The term “trisubstituted amino” refers to an amino group wherein the nitrogen atom directly attached to the parent molecule is substituted with three groups, and includes groups selected from —N(R^{bb})₃ and —N(R^{bb})₃⁺X⁻, wherein R^{bb} and X⁻ are as defined herein.

The term “sulfonyl” refers to a group selected from —SO₂N(R^{bb})₂, —SO₂R^{aa}, and —So₂OR^{aa}, wherein R^{aa} and R^{bb} are as defined herein.

The term “sulfinyl” refers to the group —S(═O)R^{aa}, wherein R^{aa} is as defined herein.

The term “carbonyl” refers a group wherein the carbon directly attached to the parent molecule is sp² hybridized, and is substituted with an oxygen, nitrogen or sulfur atom, e.g., a group selected from ketones (—C(═O)R^{aa}), carboxylic acids (—CO₂H), aldehydes (—CHO), esters (—CO₂R^{aa}, —C(═O)SR^{aa}, —C(═S)SR^{aa}), amides (—C(═O)N(R^{bb})₂, —C(═O)NR^{bb}SO₂R^{aa}, —C(═S)N(R^{bb})₂), and imines (—C(═NR^{bb})R^{aa}, —C(═NR^{bb})OR^{aa}), —C(═NR^{bb})N(R^{bb})₂), wherein R^{aa} and R^{bb} are as defined herein.

The term “silyl” refers to the group —Si(R^{aa})₃, wherein R^{aa} is as defined herein.

The term “boronyl” refers to boranes, boronic acids, boronic esters, borinic acids, and borinic esters, e.g., boronyl groups of the formula —B(R^{aa})₂, —B(OR^{cc})₂, and —BR^{aa}(OR^{cc}), wherein R^{aa} and R^{cc} are as defined herein.

The term “phosphino” refers to the group —P(R^{cc})₃, wherein R^{cc} is as defined herein. An exemplary phosphino group is triphenylphosphine.

The term “phosphono” refers to the group —O(P═O)(OR^{cc})R^{aa}, wherein R^{aa} and R^{cc} are as defined herein.

The term “phosphoramido” refers to the group —O(P═O)(NR^{bb})₂, wherein each R^{bb} is as defined herein.

The term “stannyl” refers to the group —Sn(R^{cc})₃, wherein R^{cc} is as defined herein.

The term “germyl” refers to the group —Ge(R^{cc})₃, wherein R^{cc} is as defined herein.

The term “arsenyl” refers to the group —As(R^{cc})₃, wherein R^{cc} is as defined herein.

The term “oxo” refers to the group ═O, and the term “thiooxo” refers to the group ═S.

In certain embodiments, a nitrogen atom of a moiety described herein is a primary, secondary, tertiary, or quaternary nitrogen atom. In certain embodiments, each nitrogen atom substituent is independently selected from the group consisting of nitrogen protecting groups, —OH, —OR^{aa}, —N(R^{cc})₂, —CN, —C(═O)R^{aa}, —C(═O)N(R^{cc})₂, —CO₂R^{aa}, —SO₂R^{aa}, —C(═NR^{bb})R^{aa}, —C(═NR^{cc})OR^{aa}, —C(═NR^{cc})N(R^{cc})₂, —SO₂N(R^{cc})₂, —SO₂R^{cc}, —SO₂OR^{cc}, —SOR^{aa}, —C(═S)N(R^{cc})₂, —C(═O)SR^{cc}, —C(═S)SR^{cc}, —P(═O)₂R^{aa}, —P(═O)(R^{aa})₂, —P(═O)₂N(R^{cc})₂, —P(═O)(NR^{cc})₂, C₁₋₁₀ alkyl, C₁₋₁₀ perhaloalkyl, C₂₋₁₀ alkenyl, C₂₋₁₀ alkynyl, heteroC₁₋₁₀alkyl, heteroC₂₋₁₀alkenyl, heteroC₂₋₁₀ alkynyl, C₃₋₁₀ carbocyclyl, 3-14 membered heterocyclyl, C₆₋₁₄ aryl, 5-14 membered heteroaryl, and ═O, wherein each of the alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd}.

In certain embodiments, the nitrogen atom substituents are independently substituted (e.g., substituted with one or more halogen) or unsubstituted C₁₋₆ alkyl, —C(═O)R^{aa}, —CO₂R^{aa}, —C(═O)N(R^{bb})₂, or a nitrogen protecting group. In certain embodiments, the nitrogen atom substituents are independently substituted (e.g., substituted with one or more halogen) or unsubstituted C₁₋₆ alkyl, —C(═O)R^{aa}, —CO₂R^{aa}, —C(═O)N(R^{bb})₂, or a nitrogen protecting group, wherein R^{aa} is hydrogen, substituted (e.g., substituted with one or more halogen) or unsubstituted C₁₋₆ alkyl, or an oxygen protecting group when attached to an oxygen atom; and each R^{bb} is independently hydrogen, substituted (e.g., substituted with one or more halogen) or unsubstituted C₁₋₆ alkyl, or a nitrogen protecting group. In certain embodiments, the nitrogen atom substituents are independently substituted (e.g., substituted with one or more halogen) or unsubstituted C₁₋₆ alkyl or a nitrogen protecting group.

Nitrogen protecting groups may also be referred to as “amino protecting groups”. Nitrogen protecting groups are well known in the art and include those described in detail in Protecting Groups in Organic Synthesis, T. W. Greene and P. G. M. Wuts, 3^{rd} edition, John Wiley & Sons, 1999, incorporated herein by reference. In certain embodiments, each nitrogen protecting group is independently selected from the group consisting of —OH, —OR^{aa}, —N(R^{cc})₂, —C(═O)R^{aa}, —C(═O)N(R^{cc})₂, —CO₂R^{aa}, —SO₂R^{aa}, —C(═NR^{cc})R^{aa}, —C(═NR^{cc})OR^{aa}, —C(═NR^{cc})N(R^{cc})₂, —SO₂N(R^{cc})₂, —SO₂R^{cc}, —SO₂OR^{cc}, —SOR^{aa}, —C(═S)N(R^{cc})₂, —C(═O)SR^{cc}, —C(═S)SR^{cc}, C₁₋₁₀ alkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl groups, wherein each of the alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups.

For example, nitrogen protecting groups such as amide groups (e.g., —C(═O)R^{aa}) include formamide, acetamide, chloroacetamide, trichloroacetamide, trifluoroacetamide, phenylacetamide, 3-phenylpropanamide, picolinamide, 3-pyridylcarboxamide, N-benzoylphenylalanyl derivative, benzamide, p-phenylbenzamide, o-nitrophenylacetamide, o-nitrophenoxyacetamide, acetoacetamide, (N′-dithiobenzyloxyacylamino)acetamide, 3-(p-hydroxyphenyl)propanamide, 3-(o-nitrophenyl)propanamide, 2-methyl-2-(o-nitrophenoxy)propanamide, 2-methyl-2-(o-phenylazophenoxy)propanamide, 4-chlorobutanamide, 3-methyl-3-nitrobutanamide, o-nitrocinnamide, N-acetylmethionine derivative, o-nitrobenzamide and o-(benzoyloxymethyl)benzamide.

Nitrogen protecting groups such as carbamate groups (e.g., —C(═O)OR^{aa}) include methyl carbamate, ethyl carbamate, 9-fluorenylmethyl carbamate (Fmoc), 9-(2-sulfo)fluorenylmethyl carbamate, 9-(2,7-dibromo)fluorenylmethyl carbamate, 2,7-di-t-butyl-[9-(10,10-dioxo-10,10,10,10-tetrahydrothioxanthyl)]methyl carbamate (DBD-Tmoc), 4-methoxyphenacyl carbamate (Phenoc), 2,2,2-trichloroethyl carbamate (Troc), 2-trimethylsilylethyl carbamate (Teoc), 2-phenylethyl carbamate, 1-(1-adamantyl)-1-methylethyl carbamate (Adpoc), 1,1-dimethyl-2-haloethyl carbamate, 1,1-dimethyl-2,2-dibromoethyl carbamate (DB-t-BOC), 1,1-dimethyl-2,2,2-trichloroethyl carbamate (TCBOC), 1-methyl-1-(4-biphenylyl)ethyl carbamate (Bpoc), 1-(3,5-di-t-butylphenyl)-1-methylethyl carbamate (t-Bumeoc), 2-(2′- and 4′-pyridyl)ethyl carbamate (Pyoc), 2-(N,N-dicyclohexylcarboxamido)ethyl carbamate, t-butyl carbamate (BOC or Boc), 1-adamantyl carbamate (Adoc), vinyl carbamate (Voc), allyl carbamate (Alloc), 1-isopropylallyl carbamate (Ipaoc), cinnamyl carbamate (Coc), 4-nitrocinnamyl carbamate (Noc), 8-quinolyl carbamate, N-hydroxypiperidinyl carbamate, alkyldithio carbamate, benzyl carbamate (Cbz), p-methoxybenzyl carbamate (Moz), p-nitrobenzyl carbamate, p-bromobenzyl carbamate, p-chlorobenzyl carbamate, 2,4-dichlorobenzyl carbamate, 4-methylsulfinylbenzyl carbamate (Msz), 9-anthrylmethyl carbamate, diphenylmethyl carbamate, 2-methylthioethyl carbamate, 2-methylsulfonylethyl carbamate, 2-(p-toluenesulfonyl)ethyl carbamate, [2-(1,3-dithianyl)]methyl carbamate (Dmoc), 4-methylthiophenyl carbamate (Mtpc), 2,4-dimethylthiophenyl carbamate (Bmpc), 2-phosphonioethyl carbamate (Peoc), 2-triphenylphosphonioisopropyl carbamate (Ppoc), 1,1-dimethyl-2-cyanoethyl carbamate, m-chloro-p-acyloxybenzyl carbamate, p-(dihydroxyboryl)benzyl carbamate, 5-benzisoxazolylmethyl carbamate, 2-(trifluoromethyl)-6-chromonylmethyl carbamate (Tcroc), m-nitrophenyl carbamate, 3,5-dimethoxybenzyl carbamate, o-nitrobenzyl carbamate, 3,4-dimethoxy-6-nitrobenzyl carbamate, phenyl(o-nitrophenyl)methyl carbamate, t-amyl carbamate, S-benzyl thiocarbamate, p-cyanobenzyl carbamate, cyclobutyl carbamate, cyclohexyl carbamate, cyclopentyl carbamate, cyclopropylmethyl carbamate, p-decyloxybenzyl carbamate, 2,2-dimethoxyacylvinyl carbamate, o-(N,N-dimethylcarboxamido)benzyl carbamate, 1,1-dimethyl-3-(N,N-dimethylcarboxamido)propyl carbamate, 1,1-dimethylpropynyl carbamate, di(2-pyridyl)methyl carbamate, 2-furanylmethyl carbamate, 2-iodoethyl carbamate, isobornyl carbamate, isobutyl carbamate, isonicotinyl carbamate, p-(p′-methoxyphenylazo)benzyl carbamate, 1-methylcyclobutyl carbamate, 1-methylcyclohexyl carbamate, 1-methyl-1-cyclopropylmethyl carbamate, 1-methyl-1-(3,5-dimethoxyphenyl)ethyl carbamate, 1-methyl-1-(p-phenylazophenyl)ethyl carbamate, 1-methyl-1-phenylethyl carbamate, 1-methyl-1-(4-pyridyl)ethyl carbamate, phenyl carbamate, p-(phenylazo)benzyl carbamate, 2,4,6-tri-t-butylphenyl carbamate, 4-(trimethylammonium)benzyl carbamate, and 2,4,6-trimethylbenzyl carbamate.

Nitrogen protecting groups such as sulfonamide groups (e.g., —S(═O)₂R^{aa}) include p-toluenesulfonamide (Ts), benzenesulfonamide, 2,3,6-trimethyl-4-methoxybenzenesulfonamide (Mtr), 2,4,6-trimethoxybenzenesulfonamide (Mtb), 2,6-dimethyl-4-methoxybenzenesulfonamide (Pme), 2,3,5,6-tetramethyl-4-methoxybenzenesulfonamide (Mte), 4-methoxybenzenesulfonamide (Mbs), 2,4,6-trimethylbenzenesulfonamide (Mts), 2,6-dimethoxy-4-methylbenzenesulfonamide (iMds), 2,2,5,7,8-pentamethylchroman-6-sulfonamide (Pmc), methanesulfonamide (Ms), β-trimethylsilylethanesulfonamide (SES), 9-anthracenesulfonamide, 4-(4′,8′-dimethoxynaphthylmethyl)benzenesulfonamide (DNMBS), benzylsulfonamide, trifluoromethylsulfonamide, and phenacylsulfonamide.

Other nitrogen protecting groups includephenothiazinyl-(10)-acyl derivative, N′-p-toluenesulfonylaminoacyl derivative, N′-phenylaminothioacyl derivative, N-benzoylphenylalanyl derivative, N-acetylmethionine derivative, 4,5-diphenyl-3-oxazolin-2-one, N-phthalimide, N-dithiasuccinimide (Dts), N-2,3-diphenylmaleimide, N-2,5-dimethylpyrrole, N-1,1,4,4-tetramethyldisilylazacyclopentane adduct (STABASE), 5-substituted 1,3-dimethyl-1,3,5-triazacyclohexan-2-one, 5-substituted 1,3-dibenzyl-1,3,5-triazacyclohexan-2-one, 1-substituted 3,5-dinitro-4-pyridone, N-methylamine, N-allylamine, N-[2-(trimethylsilyl)ethoxy]methylamine (SEM), N-3-acetoxypropylamine, N-(1-isopropyl-4-nitro-2-oxo-3-pyrrolin-3-yl)amine, quaternary ammonium salts, N-benzylamine, N-di(4-methoxyphenyl)methylamine, N-5-dibenzosuberylamine, N-triphenylmethylamine (Tr), N-[(4-methoxyphenyl)diphenylmethyl]amine (MMTr), N-9-phenylfluorenylamine (PhF), N-2,7-dichloro-9-fluorenylmethyleneamine, N-ferrocenylmethylamino (Fcm), N-2-picolylamino N′-oxide, N-1,1-dimethylthiomethyleneamine, N-benzylideneamine, N-p-methoxybenzylideneamine, N-diphenylmethyleneamine, N-[(2-pyridyl)mesityl]methyleneamine, N—(N′,N′-dimethylaminomethylene)amine, N,N′-isopropylidenediamine, N-p-nitrobenzylideneamine, N-salicylideneamine, N-5-chlorosalicylideneamine, N-(5-chloro-2-hydroxyphenyl)phenylmethyleneamine, N-cyclohexylideneamine, N-(5,5-dimethyl-3-oxo-1-cyclohexenyl)amine, N-borane derivative, N-diphenylborinic acid derivative, N-[phenyl(pentaacylchromium- or tungsten)acyl]amine, N-copper chelate, N-zinc chelate, N-nitroamine, N-nitrosoamine, amine N-oxide, diphenylphosphinamide (Dpp), dimethylthiophosphinamide (Mpt), diphenylthiophosphinamide (Ppt), dialkyl phosphoramidates, dibenzyl phosphoramidate, diphenyl phosphoramidate, benzenesulfenamide, o-nitrobenzenesulfenamide (Nps), 2,4-dinitrobenzenesulfenamide, pentachlorobenzenesulfenamide, 2-nitro-4-methoxybenzenesulfenamide, triphenylmethylsulfenamide, and 3-nitropyridinesulfenamide (Npys).

In certain embodiments, a nitrogen protecting group is Bn, Boc, Cbz, Fmoc, trifluoroacetyl, triphenylmethyl, acetyl, or Ts.

In certain embodiments, the oxygen atom substituents are independently substituted (e.g., substituted with one or more halogen) or unsubstituted C₁₋₆ alkyl, —C(═O)Ra^{aa},—CO₂R^{aa}, —C(═O)N(R^{bb})₂, or an oxygen protecting group. In certain embodiments, the oxygen atom substituents are independently substituted (e.g., substituted with one or more halogen) or unsubstituted C₁₋₆ alkyl, —C(═O)R^{aa}, —CO₂R^{aa}, —C(═O)N(R^{bb})₂, or an oxygen protecting group, wherein R^{aa} is hydrogen, substituted (e.g., substituted with one or more halogen) or unsubstituted C₁₋₆ alkyl, or an oxygen protecting group when attached to an oxygen atom; and each R^{bb} is independently hydrogen, substituted (e.g., substituted with one or more halogen) or unsubstituted C₁₋₆ alkyl, or a nitrogen protecting group. In certain embodiments, the oxygen atom substituents are independently substituted (e.g., substituted with one or more halogen) or unsubstituted C₁₋₆ alkyl or an oxygen protecting group.

Oxygen protecting groups may also be referred to as “hydroxyl protecting groups”. Oxygen protecting groups are well known in the art and include those described in detail in Protecting Groups in Organic Synthesis, T. W. Greene and P. G. M. Wuts, 3^{rd} edition, John Wiley & Sons, 1999, incorporated herein by reference. In certain embodiments, each oxygen protecting group is independently selected from the group consisting of —R^{aa}, —N(R^{bb})₂, —C(═O)SR^{aa}, —C(═O)R^{aa}, —CO₂R^{aa}, —C(═O)N(R^{bb})₂, —C(═NR^{bb})R^{aa}, —C(═NR^{bb})OR^{aa}, —C(═NR^{bb})N(R^{bb})₂, —S(═O)R^{aa}, —SO₂R^{aa}, —Si(R^{aa})₃, —P(R^{cc})₂, —P(R^{cc})₃, —P(═O)₂R^{aa}, —P(═O)(R^{aa})₂, —P(═O)(OR^{cc})₂, —P(═O)₂N(R^{bb})₂, —P(═O)(NR^{bb})₂, methyl, methoxylmethyl (MOM), methylthiomethyl (MTM), t-butylthiomethyl, (phenyldimethylsilyl)methoxymethyl (SMOM), benzyloxymethyl (BOM), p-methoxybenzyloxymethyl (PMBM), (4-methoxyphenoxy)methyl (p-AOM), guaiacolmethyl (GUM), t-butoxymethyl, 4-pentenyloxymethyl (POM), siloxymethyl, 2-methoxyethoxymethyl (MEM), 2,2,2-trichloroethoxymethyl, bis(2-chloroethoxy)methyl, 2-(trimethylsilyl)ethoxymethyl (SEMOR), tetrahydropyranyl (THP), 3-bromotetrahydropyranyl, tetrahydrothiopyranyl, 1-methoxycyclohexyl, 4-methoxytetrahydropyranyl (MTHP), 4-methoxytetrahydrothiopyranyl, 4-methoxytetrahydrothiopyranyl S,S-dioxide, 1-[(2-chloro-4-methyl)phenyl]-4-methoxypiperidin-4-yl (CTMP), 1,4-dioxan-2-yl, tetrahydrofuranyl, tetrahydrothiofuranyl, 2,3,3a,4,5,6,7,7a-octahydro-7,8,8-trimethyl-4,7-methanobenzofuran-2-yl, 1-ethoxyethyl, 1-(2-chloroethoxy)ethyl, 1-methyl-1-methoxyethyl, 1-methyl-1-benzyloxyethyl, 1-methyl-1-benzyloxy-2-fluoroethyl, 2,2,2-trichloroethyl, 2-trimethylsilylethyl, 2-(phenylselenyl)ethyl, t-butyl, allyl, p-chlorophenyl, p-methoxyphenyl, 2,4-dinitrophenyl, benzyl (Bn), p-methoxybenzyl, 3,4-dimethoxybenzyl, o-nitrobenzyl, p-nitrobenzyl, p-halobenzyl, 2,6-dichlorobenzyl, p-cyanobenzyl, p-phenylbenzyl, 2-picolyl, 4-picolyl, 3-methyl-2-picolyl N-oxido, diphenylmethyl, p,p′-dinitrobenzhydryl, 5-dibenzosuberyl, triphenylmethyl, α-naphthyldiphenylmethyl, p-methoxyphenyldiphenylmethyl, di(p-methoxyphenyl)phenylmethyl, tri(p-methoxyphenyl)methyl, 4-(4′-bromophenacyloxyphenyl)diphenylmethyl, 4,4′,4″-tris(4,5-dichlorophthalimidophenyl)methyl, 4,4′,4″-tris(levulinoyloxyphenyl)methyl, 4,4′,4″-tris(benzoyloxyphenyl)methyl, 3-(imidazol-1-yl)bis(4′,4″-dimethoxyphenyl)methyl, 1,1-bis(4-methoxyphenyl)-1′-pyrenylmethyl, 9-anthryl, 9-(9-phenyl)xanthenyl, 9-(9-phenyl-10-oxo)anthryl, 1,3-benzodithiolan-2-yl, benzisothiazolyl S,S-dioxido, trimethylsilyl (TMS), triethylsilyl (TES), triisopropylsilyl (TIPS), dimethylisopropylsilyl (IPDMS), diethylisopropylsilyl (DEIPS), dimethylthexylsilyl, t-butyldimethylsilyl (TBDMS), t-butyldiphenylsilyl (TBDPS), tribenzylsilyl, tri-p-xylylsilyl, triphenylsilyl, diphenylmethylsilyl (DPMS), t-butylmethoxyphenylsilyl (TBMPS), formate, benzoylformate, acetate, chloroacetate, dichloroacetate, trichloroacetate, trifluoroacetate, methoxyacetate, triphenylmethoxyacetate, phenoxyacetate, p-chlorophenoxyacetate, 3-phenylpropionate, 4-oxopentanoate (levulinate), 4,4-(ethylenedithio)pentanoate (levulinoyldithioacetal), pivaloate, adamantoate, crotonate, 4-methoxycrotonate, benzoate, p-phenylbenzoate, 2,4,6-trimethylbenzoate (mesitoate), methyl carbonate, 9-fluorenylmethyl carbonate (Fmoc), ethyl carbonate, 2,2,2-trichloroethyl carbonate (Troc), 2-(trimethylsilyl)ethyl carbonate (TMSEC), 2-(phenylsulfonyl) ethyl carbonate (Psec), 2-(triphenylphosphonio) ethyl carbonate (Peoc), isobutyl carbonate, vinyl carbonate, allyl carbonate, t-butyl carbonate (BOC or Boc), p-nitrophenyl carbonate, benzyl carbonate, p-methoxybenzyl carbonate, 3,4-dimethoxybenzyl carbonate, o-nitrobenzyl carbonate, p-nitrobenzyl carbonate, S-benzyl thiocarbonate, 4-ethoxy-1-napththyl carbonate, methyl dithiocarbonate, 2-iodobenzoate, 4-azidobutyrate, 4-nitro-4-methylpentanoate, o-(dibromomethyl)benzoate, 2-formylbenzenesulfonate, 2-(methylthiomethoxy)ethyl, 4-(methylthiomethoxy)butyrate, 2-(methylthiomethoxymethyl)benzoate, 2,6-dichloro-4-methylphenoxyacetate, 2,6-dichloro-4-(1,1,3,3-tetramethylbutyl)phenoxyacetate, 2,4-bis(1,1-dimethylpropyl)phenoxyacetate, chlorodiphenylacetate, isobutyrate, monosuccinoate, (E)-2-methyl-2-butenoate, o-(methoxyacyl)benzoate, α-naphthoate, nitrate, alkyl N,N,N′,N′-tetramethylphosphorodiamidate, alkyl N-phenylcarbamate, borate, dimethylphosphinothioyl, alkyl 2,4-dinitrophenylsulfenate, sulfate, methanesulfonate (mesylate), benzylsulfonate, and tosylate (Ts).

In certain embodiments, an oxygen protecting group is silyl, TBDPS, TBDMS, TIPS, TES, TMS, MOM, THP, t-Bu, Bn, allyl, acetyl, pivaloyl, or benzoyl.

In certain embodiments, each of the sulfur atom substituents is independently substituted (e.g., substituted with one or more halogen) or unsubstituted C₁₋₆ alkyl, —C(═O)R^{aa}, —CO₂R^{aa}, —C(═O)N(R^{bb})₂, a sulfur protecting group, or ═O. In certain embodiments, each of the sulfur atom substituents is independently substituted (e.g., substituted with one or more halogen) or unsubstituted C₁₋₆ alkyl, —C(═O)R^{aa}, —CO₂R^{aa}, —C(═O)N(R^{bb})₂, a sulfur protecting group, or ═O, wherein R^{aa} is hydrogen, substituted (e.g., substituted with one or more halogen) or unsubstituted C₁₋₆ alkyl, or an oxygen protecting group when attached to an oxygen atom; and each R^{bb} is independently hydrogen, substituted (e.g., substituted with one or more halogen) or unsubstituted C₁₋₆ alkyl, or a nitrogen protecting group. In certain embodiments, each of the sulfur atom substituents is independently substituted (e.g., substituted with one or more halogen) or unsubstituted C₁₋₆ alkyl or a sulfur protecting group.

Sulfur protecting groups may also be referred to as “thiol protecting groups”. Sulfur protecting groups are well known in the art and include those described in detail in Protecting Groups in Organic Synthesis, T. W. Greene and P. G. M. Wuts, 3^{rd} edition, John Wiley & Sons, 1999, incorporated herein by reference. In certain embodiments, each sulfur protecting group is independently selected from the group consisting of —R^{aa}, —N(R^{bb})₂, —C(═O)SR^{aa}, —C(═O)R^{aa}, —CO₂R^{aa}, —C(═O)N(R^{bb})₂, —C(═NR^{bb})R^{aa}, —C(═NR^{bb})OR^{aa}, —C(═NR^{bb})N(R^{bb})₂, —S(═O)R^{aa}, —SO₂R^{aa}, —Si(R^{aa})₃, —P(R^{cc})₂, —P(R^{cc})₃, —P(═O)₂R^{aa}, —P(═O)(R^{aa})₂, —P(═O)(OR^{cc})₂, —P(═O)₂N(R^{bb})₂, and —P(═O)(NR^{bb})₂.

In certain embodiments, the molecular weight of a substituent is lower than 250, lower than 200, lower than 150, lower than 100, or lower than 50 g/mol. In certain embodiments, a substituent consists of carbon, hydrogen, fluorine, chlorine, bromine, iodine, oxygen, sulfur, nitrogen, and/or silicon atoms. In certain embodiments, a substituent consists of carbon, hydrogen, fluorine, chlorine, bromine, iodine, oxygen, sulfur, and/or nitrogen atoms. In certain embodiments, a substituent consists of carbon, hydrogen, fluorine, chlorine, bromine, and/or iodine atoms. In certain embodiments, a substituent consists of carbon, hydrogen, fluorine, and/or chlorine atoms. In certain embodiments, a substituent comprises 0, 1, 2, or 3 hydrogen bond donors. In certain embodiments, a substituent comprises 0, 1, 2, or 3 hydrogen bond acceptors.

The term “heteroatom” refers to an atom that is not hydrogen or carbon. In certain embodiments, the heteroatom is oxygen, nitrogen, or sulfur. In certain embodiments, the heteroatom is silicon. In certain embodiments, the heteroatom is phosphorus. In certain embodiments, the heteroatom is boron.

A “counterion” or “anionic counterion” is a negatively charged group associated with a positively charged group in order to maintain electronic neutrality. An anionic counterion may be monovalent (i.e., including one formal negative charge). An anionic counterion may also be multivalent (i.e., including more than one formal negative charge), such as divalent or trivalent. Exemplary counterions include halide ions (e.g., F⁻, Cl⁻, Br⁻, I⁻), NO₃⁻, Cl₄⁻, OH⁻, H₂PO₄⁻, HCO₃⁻, HSO₄⁻, sulfonate ions (e.g., methanesulfonate, trifluoromethanesulfonate, p-toluenesulfonate, benzenesulfonate, 10-camphor sulfonate, naphthalene-2-sulfonate, naphthalene-1-sulfonic acid-5-sulfonate, ethan-1-sulfonic acid-2-sulfonate, and the like), carboxylate ions (e.g., acetate, propanoate, benzoate, glycerate, lactate, tartrate, glycolate, gluconate, and the like), BF₄⁻, PF₄⁻, PF₆⁻, AsF₆⁻, SbF₆⁻, B[3,5-(CF₃)₂C₆H₃]₄]⁻, B(C₆F₅)₄⁻, BPh₄⁻, Al(OC(CF₃)₃)₄⁻, and carborane anions (e.g., CB₁₁H₁₂⁻ or (HCB₁₁Me₅Br₆)⁻). Exemplary counterions which may be multivalent include CO₃²⁻, HPO₄²⁻, PO₄³⁻, B₄O₇²⁻, SO₄²⁻, S₂O₃²⁻, carboxylate anions (e.g., tartrate, citrate, fumarate, maleate, malate, malonate, gluconate, succinate, glutarate, adipate, pimelate, suberate, azelate, sebacate, salicylate, phthalates, aspartate, glutamate, and the like), and carboranes.

The term “leaving group” is given its ordinary meaning in the art of synthetic organic chemistry and refers to an atom or a group capable of being displaced by a nucleophile.

Examples of suitable leaving groups include halogen (such as F, Cl, Br, or I (iodine)), alkoxycarbonyloxy, aryloxycarbonyloxy, alkanesulfonyloxy, arenesulfonyloxy, alkyl-carbonyloxy (e.g., acetoxy), arylcarbonyloxy, aryloxy, methoxy, N,O-dimethylhydroxylamino, pixyl, and haloformates. In some cases, the leaving group is a sulfonic acid ester, such as toluenesulfonate (tosylate, —OTs), methanesulfonate (mesylate, —OMs), p-bromobenzenesulfonyloxy (brosylate, —OBs), —OS(═O)₂(CF₂)₃CF₃ (nonaflate, —ONf), or trifluoromethanesulfonate (triflate, —OTf). In some cases, the leaving group is a brosylate, such as p-bromobenzenesulfonyloxy. In some cases, the leaving group is a nosylate, such as 2-nitrobenzenesulfonyloxy. In some embodiments, the leaving group is a sulfonate-containing group. In some embodiments, the leaving group is a tosylate group. The leaving group may also be a phosphineoxide (e.g., formed during a Mitsunobu reaction) or an internal leaving group such as an epoxide or cyclic sulfate.

The term “isotopically labeled compound” refers to a derivative of a compound that only structurally differs from the compound in that at least one atom of the derivative includes at least one isotope enriched above (e.g., enriched 3-, 10-, 30-, 100-, 300-, 1,000-, 3,000- or 10,000-fold above) its natural abundance, whereas each atom of the compound includes isotopes at their natural abundances. In certain embodiments, the isotope enriched above its natural abundance is ²H. In certain embodiments, the isotope enriched above its natural abundance is ¹³C, ¹⁵N, or ¹⁸O.

The term “salt” refers to ionic compounds that result from the neutralization reaction of an acid and a base. A salt is composed of one or more cations (positively charged ions) and one or more anions (negative ions) so that the salt is electrically neutral (without a net charge). Salts of the compounds of this invention include those derived from inorganic and organic acids and bases. Examples of acid addition salts are salts of an amino group formed with inorganic acids, such as hydrochloric acid, hydrobromic acid, phosphoric acid, sulfuric acid, and perchloric acid, or with organic acids, such as acetic acid, oxalic acid, maleic acid, tartaric acid, citric acid, succinic acid, or malonic acid or by using other methods known in the art such as ion exchange. Other salts include adipate, alginate, ascorbate, aspartate, benzenesulfonate, benzoate, bisulfate, borate, butyrate, camphorate, camphorsulfonate, citrate, cyclopentanepropionate, digluconate, dodecylsulfate, ethanesulfonate, formate, fumarate, glucoheptonate, glycerophosphate, gluconate, hemisulfate, heptanoate, hexanoate, hydroiodide, 2-hydroxy-ethanesulfonate, lactobionate, lactate, laurate, lauryl sulfate, malate, maleate, malonate, methanesulfonate, 2-naphthalenesulfonate, nicotinate, nitrate, oleate, oxalate, palmitate, pamoate, pectinate, persulfate, 3-phenylpropionate, phosphate, picrate, pivalate, propionate, stearate, succinate, sulfate, tartrate, thiocyanate, p-toluenesulfonate, undecanoate, valerate, hippurate, and the like. Salts derived from appropriate bases include alkali metal, alkaline earth metal, ammonium, and N⁺(C₁₋₄ alkyl)₄ salts. Representative alkali or alkaline earth metal salts include sodium, lithium, potassium, calcium, magnesium, and the like. Further salts include ammonium, quatemary ammonium, and amine cations formed using counterions such as halide, hydroxide, carboxylate, sulfate, phosphate, nitrate, lower alkyl sulfonate, and aryl sulfonate.

The term “solvate” refers to forms of the compound, or a salt thereof, that are associated with a solvent, usually by a solvolysis reaction. This physical association may include hydrogen bonding. Conventional solvents include water, methanol, ethanol, acetic acid, DMSO, THF, diethyl ether, and the like. The compounds described herein may be prepared, e.g., in crystalline form, and may be solvated. Suitable solvates include pharmaceutically acceptable solvates and further include both stoichiometric solvates and non-stoichiometric solvates. In certain instances, the solvate will be capable of isolation, for example, when one or more solvent molecules are incorporated in the crystal lattice of a crystalline solid. “Solvate” encompasses both solution-phase and isolatable solvates. Representative solvates include hydrates, ethanolates, and methanolates.

The term “hydrate” refers to a compound that is associated with water. Typically, the number of the water molecules contained in a hydrate of a compound is in a definite ratio to the number of the compound molecules in the hydrate. Therefore, a hydrate of a compound may be represented, for example, by the general formula R·x H₂O, wherein R is the compound, and x is a number greater than 0. A given compound may form more than one type of hydrate, including, e.g., monohydrates (x is 1), lower hydrates (x is a number greater than 0 and smaller than 1, e.g., hemihydrates (R·0.5H₂O)), and polyhydrates (x is a number greater than 1, e.g., dihydrates (R·2H₂O) and hexahydrates (R·6H₂O)).

The term “tautomers” or “tautomeric” refers to two or more interconvertible compounds resulting from at least one formal migration of a hydrogen atom and at least one change in valency (e.g., a single bond to a double bond, a triple bond to a single bond, or vice versa). The exact ratio of the tautomers depends on several factors, including temperature, solvent, and pH. Tautomerizations (i.e., the reaction providing a tautomeric pair) may catalyzed by acid or base. Exemplary tautomerizations include keto-to-enol, amide-to-imide, lactam-to-lactim, enamine-to-imine, and enamine-to-(a different enamine) tautomerizations.

The term “polymorph” refers to a crystalline form of a compound (or a salt, hydrate, or solvate thereof). All polymorphs have the same elemental composition. Different crystalline forms usually have different X-ray diffraction patterns, infrared spectra, melting points, density, hardness, crystal shape, optical and electrical properties, stability, and solubility.

Recrystallization solvent, rate of crystallization, storage temperature, and other factors may cause one crystal form to dominate. Various polymorphs of a compound can be prepared by crystallization under different conditions.

The term “equivalent ratio” of a first compound to a second compound refers to the combined molar ratio of the C—OH, —NH₂, —NH—, ═N—OH, and —NCO of the first compound to the C—OH, —NH₂, —NH—, ═N—OH, and —NCO of the second compound. For example, the equivalent ratio of glycerol to methylene diphenyl diisocyanate at the molar ratio of 1:1 is 3:2 because 1 mole of glycerol includes 3 moles of —OH, and 1 mole of methylene diphenyl diisocyanate includes 2 moles of —NCO.

The terms “composition” and “formulation” are used interchangeably.

The term “transition temperature” refers to the midpoint of a temperature range at which a polymer undergoes a transition from a solid state (e.g., cross-linked (e.g., thermoset) state) to a flowable (e.g., lightly cross-linked or un-crosslinked (e.g., thermoplastic)) state, or the midpoint of a temperature range at which the polymer undergoes a transition from a flowable (e.g., lightly cross-linked or un-crosslinked (e.g., thermoplastic)) state to a solid state (e.g., cross-linked (e.g., thermoset) state).

### DETAILED DESCRIPTION OF CERTAIN EMBODIMENTS OF THE DISCLOSURE

In one aspect, the present disclosure provides a polymer prepared by a method comprising reacting a polymerization mixture comprising one or more types of diols, one or more types of polyols, and one or more types of isocyanates at a first temperature for a first time duration sufficient to forming the polymer, wherein:
each type of the diols is independently a compound comprising zero or more instances of C—OH, zero or more instances of —NH₂, zero or more instances of —NH—, and zero instances of each of ═N—OH and —NCO, wherein the combined number of C—OH, —NH₂, and —NH— of each of the diols is two;
each type of the polyols is independently a compound comprising zero or more instances of C—OH, zero or more instances of —NH₂, zero or more instances of —NH—, and zero instances of each of ═N—OH and —NCO, wherein the combined number of C—OH, —NH₂, and —NH— of each of the polyols is at least three;
at least one type of the diols and/or at least one type of the polyols are phenols, wherein each of the phenols is independently a diol or polyol, wherein one or more instances of —OH, —NH₂, and/or —NH— are aryl-bound; and
each type of the isocyanates is independently a compound comprising two or more instances of —NCO and zero instances of each of —OH, —NH₂, and —NH—.

In another aspect, the present disclosure provides a method of preparing a polymer comprising reacting a polymerization mixture comprising one or more types of diols, one or more types of polyols, and one or more types of isocyanates at a first temperature for a first time duration sufficient to forming the polymer, wherein:
each type of the diols is independently a compound comprising zero or more instances of C—OH, zero or more instances of —NH₂, zero or more instances of —NH—, and zero instances of each of ═N—OH and —NCO, wherein the combined number of C—OH, —NH₂, and —NH— of each of the diols is two;
each type of the polyols is independently a compound comprising zero or more instances of C—OH, zero or more instances of —NH₂, zero or more instances of —NH—, and zero instances of each of ═N—OH and —NCO, wherein the combined number of C—OH, —NH₂, and —NH— of each of the polyols is at least three;
at least one type of the diols and/or at least one type of the polyols are phenols, wherein each of the phenols is independently a diol or polyol, wherein one or more instances of —OH, —NH₂, and/or —NH— are aryl-bound; and
each type of the isocyanates is independently a compound comprising two or more instances of —NCO and zero instances of each of —OH, —NH₂, and —NH—.

In certain embodiments, the first temperature is between 20 and 40, between 40 and 60, between 60 and 80, between 80 and 100, or between 10° and 120° C., e.g., between 4° and 60° C. In certain embodiments, the first temperature is substantially constant over the first time duration. In certain embodiments, the first temperature is a variable temperature (e.g., ±5, ±10, ±15, or ±20° C.) over the first time duration.

In certain embodiments, the first time duration is between 1 minute and 1 hour, between 1 and 8 hours, between 8 and 24 hours, between 1 and 3 days, or between 3 and 7 days, e.g. between 8 and 24 hours. In certain embodiments, the first time duration is between 8 hours and 3 days.

In certain embodiments, at least one (e.g., each) type of the diols is independently a compound comprising two instances of C—OH and zero instances of each of —NH₂, —NH—, ═N—OH, and —NCO. In certain embodiments, at least one (e.g., each) type of the diols is independently a compound comprising one instance of C—OH, one instance of —NH₂ or —NH—, and zero instances of each of ═N—OH and —NCO. In certain embodiments, at least one (e.g. each) type of the diols is independently a compound comprising zero instances of C—OH, zero or more instances of —NH₂, zero or more instances of —NH—, and zero instances of each of ═N—OH and —NCO, wherein the combined number of —NH₂ and —NH— of the at least one (e.g., each) type of the diols is two. In certain embodiments, at least one (e.g., each) type of the diols is alkane or polyethylene (e.g., polyethylene having a number average molecular weight of between 300 and 3,000 g/mol), each of which is substituted with two instances of —OH and optionally one or more substituents independently selected from the group consisting of halogen, unsubstituted alkyl, and —O-(unsubstituted alkyl), as valency permits. In certain embodiments, at least one (e.g. each) type of the diols is alkane substituted with two instances of —OH and optionally one or more substituents that do not comprise —OH. In certain embodiments, at least one (e.g., each) type of the diols is polyethylene substituted with two instances of —OH and optionally one or more substituents that do not comprise —OH. In certain embodiments, at least one (e.g., each) type of the diols does not comprise two or more instances of —OH attached to the same atom (e.g., carbon atom). In certain embodiments, at least one (e.g., each) type of the diols is alkane substituted with one instance of —OH, one instance of —NH₂ or —NH—, and optionally one or more substituents that do not comprise —OH, —NH₂, and/or —NH—. In certain embodiments, at least one (e.g., each) type of the diols is polyethylene substituted with one instance of —OH, one instance of —NH₂ or —NH—, and optionally one or more substituents that do not comprise —OH, —NH₂, and/or —NH—.

In certain embodiments, at least one (e.g., each) instance of —NH₂ is part of C—NH₂. In certain embodiments, at least one (e.g., each) instance of —NH— is part of C—NH—C. In certain embodiments, at least one (e.g., each) instance of —NH— is non-aromatic —NH—. In certain embodiments, at least one (e.g., each) instance of —NH— is aromatic —NH—.

In certain embodiments, the polyethylene has a number average molecular weight of between 300 and 600, between 600 and 1,000, between 1,000 and 2,000, or between 2,000 and 3,000, g/mol.

In certain embodiments, the number average molecular weight is as determined by gel permeation chromatography.

In certain embodiments, at least one (e.g., each) type of the diols is heteroalkane or polyether (e.g., polyether having a number average molecular weight of between 300 and 3,000 g/mol), each of which is substituted with two instances of —OH and optionally one or more substituents independently selected from the group consisting of halogen, unsubstituted alkyl, and —O-(unsubstituted alkyl), as valency permits. In certain embodiments, at least one (e.g. each) type of the diols is heteroalkane substituted with two instances of —OH and optionally one or more substituents that do not comprise —OH. In certain embodiments, each heteroatom of at least one (e.g., each) instance of the heteroalkene is O. In certain embodiments, at least one (e.g., each) type of the diols is polyether substituted with two instances of —OH and optionally one or more substituents that do not comprise —OH. In certain embodiments, at least one (e.g., each) type of the diols is heteroalkane substituted with one instance of —OH, one instance of —NH₂ or —NH—, and optionally one or more substituents that do not comprise —OH, —NH₂, and/or —NH—. In certain embodiments, at least one (e.g., each) type of the diols is polyether substituted with one instance of —OH, one instance of —NH₂ or —NH—, and optionally one or more substituents that do not comprise —OH, —NH₂, and/or —NH—. In certain embodiments, the polyether has a number average molecular weight of between 300 and 600, between 600 and 1,000, between 1,000 and 2,000, or between 2,000 and 3,000, g/mol.

In certain embodiments, at least one (e.g., each) type of the diols is of the formula:

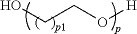

or an isotopically labeled compound thereof, wherein each instance of p1 is independently 1, 2, 3, 4, or 5; and each instance of p is independently an integer between 3 and 300. In certain embodiments, at least one (e.g., each) instance of p1 is 1. In certain embodiments, at least one (e.g., each) instance of p1 is 3. In certain embodiments, at least one (e.g., each) instance of p is independently an integer between 3 and 10, between 10 and 30, between 30 and 100, or between 100 and 300. In certain embodiments, at least one (e.g., each) instance of p is independently an integer between 10 and 20. In certain embodiments, at least one (e.g., each) type of the diols is of the formula:

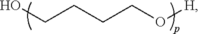

or an isotopically labeled compound thereof, wherein each instance of p is independently an integer between 10 and 30.

In certain embodiments, at least one (e.g., each) type of the diols comprises one or two instances of C—NH—C. In certain embodiments, at least one (e.g., each) type of the diols comprises one instance of C—OH and one instance of C—NH—C.

In certain embodiments, the number of types of the diols that are not the phenols is zero. In certain embodiments, the number of types of the diols that are not the phenols is one. In certain embodiments, the number of types of the diols that are not the phenols is two.

In certain embodiments, the molecular weight of at least one (e.g., each) type of the diols is between 30 and 100, between 100 and 300, between 300 and 1,000, or between 1,000 and 3,000, g/mol.

In certain embodiments, the number of types of the diols is one. In certain embodiments, the number of types of the diols is two.

In certain embodiments, each type of the diols is substantially free of water.

In certain embodiments, each substantially free of water is independently between 90% and 95%, between 95% and 97%, between 97% and 99%, between 99% and 99.5%, or between 99.5% and 99.9%, free of water.

In certain embodiments, at least one (e.g., each) type of the polyols is a triol, wherein each of the triols is independently a compound comprising zero or more instances of C—OH, zero or more instances of —NH₂, zero or more instances of —NH—, and zero instances of each of ═N—OH and —NCO, wherein the combined number of C—OH, —NH₂, and —NH— of each of the triols is three.

In certain embodiments, at least one (e.g., each) type of triols is independently a compound comprising three instances of C—OH and zero instances of each of —NH₂, —NH—, ═N—OH, and —NCO. In certain embodiments, at least one (e.g., each) type of the triols is independently a compound comprising two instances of C—OH, one instance of —NH₂ or —NH—, and zero instances of each of ═N—OH and —NCO. In certain embodiments, at least one (e.g., each) type of the triols is independently a compound comprising one instance of C—OH, zero or more instances of —NH₂, zero or more instances of —NH—, and zero instances of each of ═N—OH and —NCO, wherein the combined number of —NH₂ and —NH— of the at least one (e.g., each) type of the triols is two. In certain embodiments, at least one (e.g., each) type of the triols is independently a compound comprising zero instances of C—OH, zero or more instances of —NH₂, zero or more instances of —NH—, and zero instances of each of ═N—OH and —NCO, wherein the combined number of —NH₂ and —NH— of the at least one (e.g., each) type of the triols is three. In certain embodiments, at least one (e.g., each) type of the triols is alkane substituted with three instances of —OH and optionally one or more substituents independently selected from the group consisting of halogen, unsubstituted alkyl, and —O-(unsubstituted alkyl), as valency permits. In certain embodiments, at least one (e.g., each) type of the triols is alkane substituted with three instances of —OH.

In certain embodiments, at least one (e.g., each) type of the polyols is glycerol, or an isotopically labeled compound thereof.

In certain embodiments, at least one (e.g., each) type of the polyols is a tetraol, wherein each of the tetraols is independently a compound comprising zero or more instances of C—OH, zero or more instances of —NH₂, zero or more instances of —NH—, and zero instances of each of ═N—OH and —NCO, wherein the combined number of C—OH, —NH₂, and —NH— of each of the tetraols is four. In certain embodiments, at least one (e.g., each) type of the tetraols is independently a compound comprising four instances of C—OH and zero instances of each of —NH₂, —NH—, ═N—OH, and —NCO.

In certain embodiments, the molecular weight of at least one (e.g., each) type of the polyols is between 60 and 100, between 100 and 200, between 200 and 300, between 300 and 400, or between 400 and 600, g/mol.

In certain embodiments, the number of types of the polyols is one. In certain embodiments, the number of types of the polyols is two.

In certain embodiments, the number of types of the triols is one. In certain embodiments, the number of types of the triols is two.

In certain embodiments, the equivalent ratio of the combination of all types of the diols to the combination of all types of polyols is between 1:0.01 and 1:0.7, e.g., between 1:0.1 and 1:0.5.

In certain embodiments, the equivalent ratio of the combination of all types of the diols to the combination of all types of polyols is between 1:0.01 and 1:0.03, between 1:0.03 and 1:0.1, between 1:0.1 and 1:0.3, between 1:0.3 and 1:0.5, between 1:0.5 and 1:0.6, or between 1:0.6 and 1:0.7.

In certain embodiments, each type of the polyols is substantially free of water.

In certain embodiments, at least one (e.g., each) type of the diols and/or at least one (e.g., each) type of the polyols is a phenol, wherein each of the phenols is independently a diol or polyol, wherein one or more instances of —OH, —NH₂, and/or —NH— are aryl-bound. In certain embodiments, at least one (e.g., each) type of the phenols is a diol, wherein two instances of —OH are aryl-bound. In certain embodiments, at least one (e.g., each) type of the phenols is a diol, wherein one instance of —OH is aryl-bound. In certain embodiments, at least one (e.g., each) type of the phenols is a diol, wherein zero or more instances of —NH₂ are aryl-bound, and zero or more instances of —NH— are aryl-bound, wherein the combined number of aryl-bound —NH₂ and aryl-bound —NH— is one. In certain embodiments, at least one (e.g., each) type of the phenols is a diol, wherein zero or more instances of —NH₂ are aryl-bound, and zero or more instances of —NH— are aryl-bound, wherein the combined number of aryl-bound —NH₂ and aryl-bound —NH— is two. In certain embodiments, at least one (e.g., each) type of the phenols is a triol, wherein each of the triols is independently a compound comprising zero or more instances of C—OH, zero or more instances of —NH₂, zero or more instances of —NH—, and zero instances of each of ═N—OH and —NCO, wherein the combined number of C—OH, —NH₂, and —NH— of each of the triols is three. In certain embodiments, at least one (e.g., each) type of the phenols is a triol, wherein three instances of —OH are aryl-bound. In certain embodiments, at least one (e.g., each) type of the phenols is a triol, wherein two instances of —OH are aryl-bound. In certain embodiments, at least one (e.g., each) type of the phenols is a triol, wherein one instance of —OH is aryl-bound. In certain embodiments, at least one (e.g., each) type of the phenols is a triol, wherein zero or more instances of —NH₂ are aryl-bound, and zero or more instances of —NH— are aryl-bound, wherein the combined number of aryl-bound —NH₂ and aryl-bound —NH— is one. In certain embodiments, at least one (e.g., each) type of the phenols is a triol, wherein zero or more instances of —NH₂ are aryl-bound, and zero or more instances of —NH— are aryl-bound, wherein the combined number of aryl-bound —NH₂ and aryl-bound —NH— is two. In certain embodiments, at least one (e.g. each) type of the phenols is a triol, wherein zero or more instances of —NH₂ are aryl-bound, and zero or more instances of —NH— are aryl-bound, wherein the combined number of aryl-bound —NH₂ and aryl-bound —NH— is three.

In certain embodiments, the aryl of at least one (e.g., each) type of the phenols is phenyl optionally substituted with one or more substituents that do not comprise —OH, —NH₂, and/or —NH—.

In certain embodiments, at least one (e.g., each) type of the phenols is of the formula:

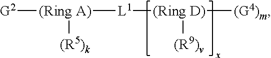

or a tautomer, isotopically labeled compound, salt, solvate, polymorph, or co-crystal thereof, wherein:
each instance of G² is independently —OH, —NH₂, or —NHR³;
each instance of R³ is independently substituted or unsubstituted alkyl, substituted or unsubstituted aryl, or a nitrogen protecting group;
each instance of Ring A is aryl;
each instance of R⁵ is independently halogen, substituted or unsubstituted alkyl, —O-(substituted or unsubstituted alkyl), —O-(substituted or unsubstituted aryl), or —O-(oxygen protecting group);
each instance of k is independently 0, 1, 2, 3, or 4, as valency permits;
each instance of L¹ is independently a single bond, substituted or unsubstituted alkylene, substituted or unsubstituted alkenylene, substituted or unsubstituted alkynylene, substituted or unsubstituted heteroalkylene, substituted or unsubstituted heteroalkenylene, or substituted or unsubstituted heteroalkynylene;
each instance of Ring D is independently aryl, heteroaryl, carbocyclyl, or heterocyclyl;
each instance of R⁹ is independently halogen, substituted or unsubstituted alkyl, —O-(substituted or unsubstituted alkyl), —O-(substituted or unsubstituted aryl), or —O-(oxygen protecting group);
each instance of v is independently 0, 1, 2, 3, or 4, as valency permits;
each instance of x is independently 0 or 1;
each instance of G⁴ is independently —OH, —NH₂, or —NHR⁴;
each instance of R⁴ is independently substituted or unsubstituted alkyl, substituted or unsubstituted aryl, or a nitrogen protecting group; and
each instance of m is independently 1, 2, 3, 4, or 5, as valency permits.

In certain embodiments, at least one (e.g., each) type of the phenols is of the formula:

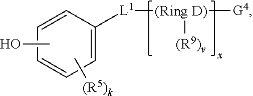

or a tautomer, isotopically labeled compound, salt, solvate, polymorph, or co-crystal thereof.

In certain embodiments, at least one (e.g. each) type of the phenols is of the formula:

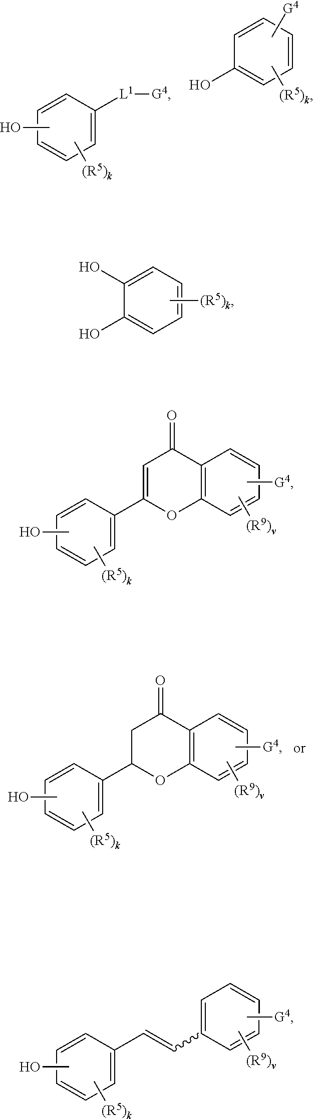

or a tautomer, isotopically labeled compound, salt, solvate, polymorph, or co-crystal thereof.

In certain embodiments, at least one (e.g., each) type of the phenols is of the formula:

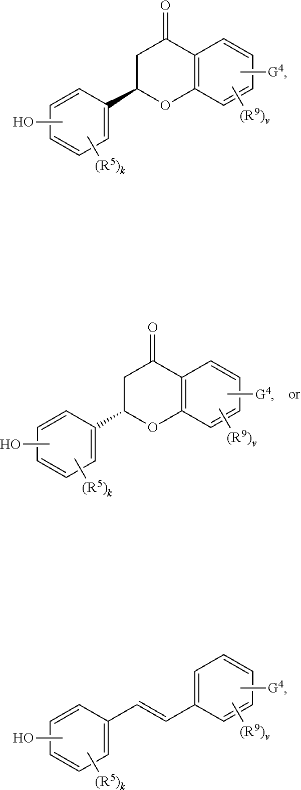

or a tautomer, isotopically labeled compound, salt, solvate, polymorph, or co-crystal thereof.

In certain embodiments, at least one (e.g., each) type of the phenols is of the formula:

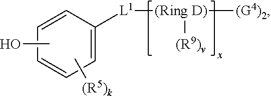

or a tautomer, isotopically labeled compound, salt, solvate, polymorph, or co-crystal thereof.

In certain embodiments, at least one (e.g., each) type of the phenols is of the formula:

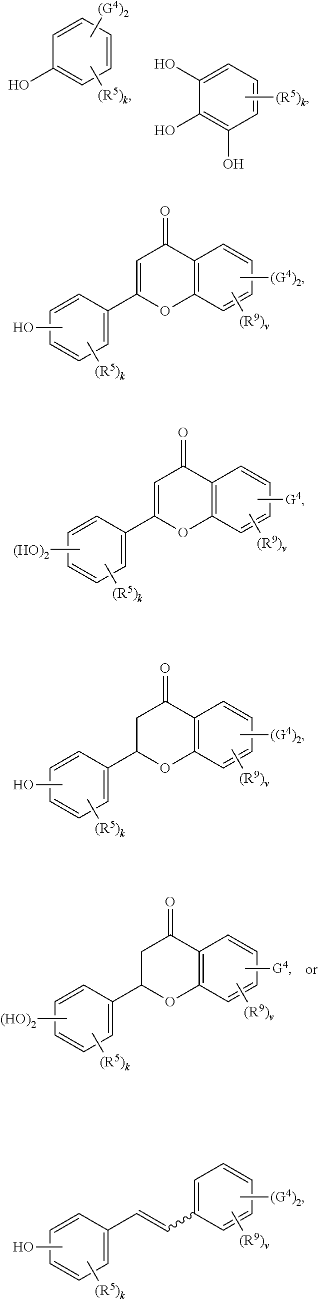

or a tautomer, isotopically labeled compound, salt, solvate, polymorph, or co-crystal thereof.

In certain embodiments, at least one (e.g., each) type of the phenols is of the formula:

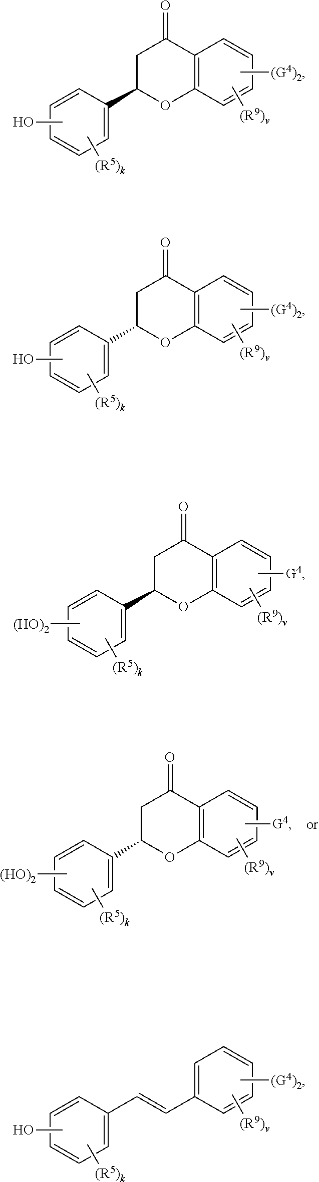

or a tautomer, isotopically labeled compound, salt, solvate, polymorph, or co-crystal thereof.

In certain embodiments, at least one (e.g., each) instance of R³ is independently substituted or unsubstituted alkyl. In certain embodiments, at least one (e.g., each) instance of R³ is independently unsubstituted C₁₋₃ alkyl. In certain embodiments, at least one (e.g., each) instance of R³ is —CH₃.

In certain embodiments, at least one (e.g., each) instance of R⁴ is independently substituted or unsubstituted alkyl. In certain embodiments, at least one (e.g., each) instance of R⁴ is independently unsubstituted C₁₋₃ alkyl. In certain embodiments, at least one (e.g., each) instance of R⁴ is —CH₃.

In certain embodiments, at least one (e.g., each) instance of G² is —OH.

In certain embodiments, at least one (e.g., each) instance of Ring A is phenyl.

In certain embodiments, at least one (e.g., each) instance of R⁵ is independently halogen, unsubstituted alkyl, or —O-(unsubstituted alkyl). In certain embodiments, at least one (e.g., each) instance of R⁵ is independently halogen, unsubstituted C₁₋₃ alkyl, or —O-(unsubstituted C₁₋₃ alkyl) (e.g., —OCH₃).

In certain embodiments, at least one (e.g., each) instance of k is independently 0 or 1.

In certain embodiments, at least one (e.g., each) instance of L¹ is a single bond. In certain embodiments, at least one (e.g., each) instance of L¹ is substituted or unsubstituted alkylene or substituted or unsubstituted alkenylene. In certain embodiments, at least one (e.g., each) instance of L¹ is unsubstituted alkylene or unsubstituted alkenylene. In certain embodiments, at least one (e.g., each) instance of L¹ is alkylene or alkenylene, each of which is independently substituted with one or more halogen, unsubstituted alkyl, and/or —O-(unsubstituted alkyl), as valency permits. In certain embodiments, at least one (e.g., each) instance of L¹ is —CH₂—, —(CH₂)₂—, —(CH₂)₃—, —(CH₂)₄—, —(CH₂)₅—, —(CH₂)₆—, (E)-CH═CH—, or (Z)—CH═CH—. In certain embodiments, at least one instance of L¹ is (unsubstituted C₁₋₆ alkylene or unsubstituted C₁₋₆ alkenylene)₀₋₁-C(═O)—NH-(unsubstituted C₁₋₆ alkylene or unsubstituted C₁₋₆ alkenylene)₀₋₁-, -(unsubstituted C₁₋₆ alkylene or unsubstituted C₁₋₆ alkenylene)₀₋₁-NH—C(═O)-(unsubstituted C₁₋₆ alkylene or unsubstituted C₁₋₆ alkenylene)₀₋₁-, -(unsubstituted C₁₋₆ alkylene or unsubstituted C₁₋₆ alkenylene)₀₋₁-O—C(═O)—NH-(unsubstituted C₁₋₆ alkylene or unsubstituted C₁₋₆ alkenylene)₀₋₁-, -(unsubstituted C₁₋₆ alkylene or unsubstituted C₁₋₆ alkenylene)₀₋₁-NH—C(═O)—O-(unsubstituted C₁₋₆ alkylene or unsubstituted C₁₋₆ alkenylene)₀₋₁-, or -(unsubstituted C₁₋₆ alkylene or unsubstituted C₁₋₆ alkenylene)₀₋₁-NH—C(═O)—NH-(unsubstituted C₁₋₆ alkylene or unsubstituted C₁₋₆ alkenylene)₀₋₁-.

In certain embodiments, at least one (e.g., each) instance of x is 0. In certain embodiments, at least one (e.g., each) instance of x is 1.

In certain embodiments, at least one (e.g., each) instance of Ring D is phenyl.

In certain embodiments, at least one (e.g., each) instance of m is 1.

In certain embodiments, at least one (e.g., each) instance of G⁴ is —OH. In certain embodiments, at least one (e.g., each) instance of G⁴ is independently —NH₂ or —NH-(unsubstituted alkyl). In certain embodiments, at least one (e.g., each) instance of G⁴ is independently —NH₂ or —NH-(unsubstituted C₁₋₃ alkyl) (e.g., —NH—CH₃).

In certain embodiments, at least one (e.g., each) type of the diols (which are phenols) is of the formula:

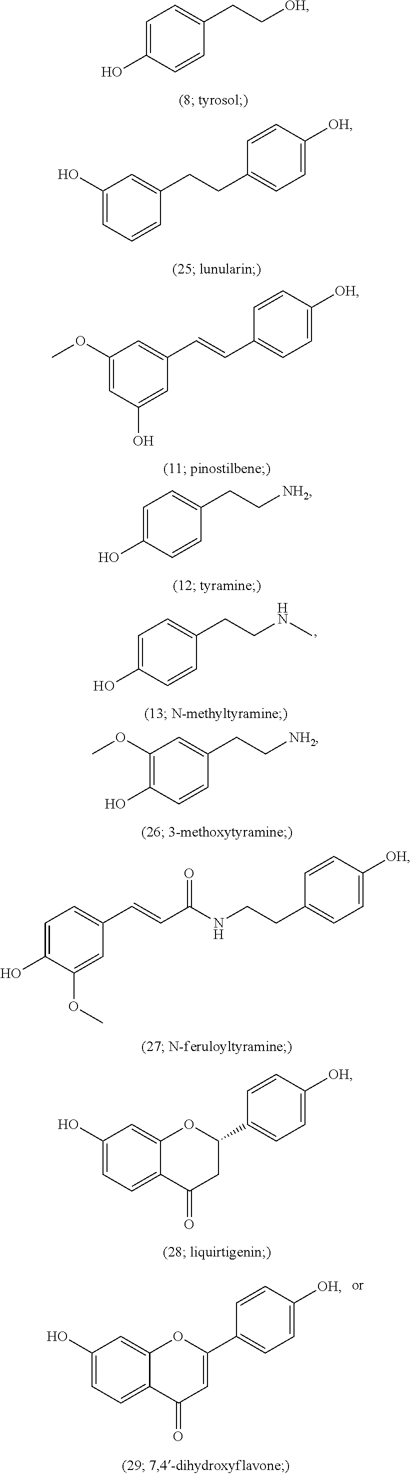

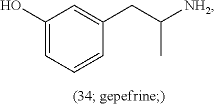

or a tautomer, isotopically labeled compound, salt, solvate, polymorph, or co-crystal thereof.

In certain embodiments, least one (e.g., each) type of the polyols (which is a triol and a phenol) is of the formula:

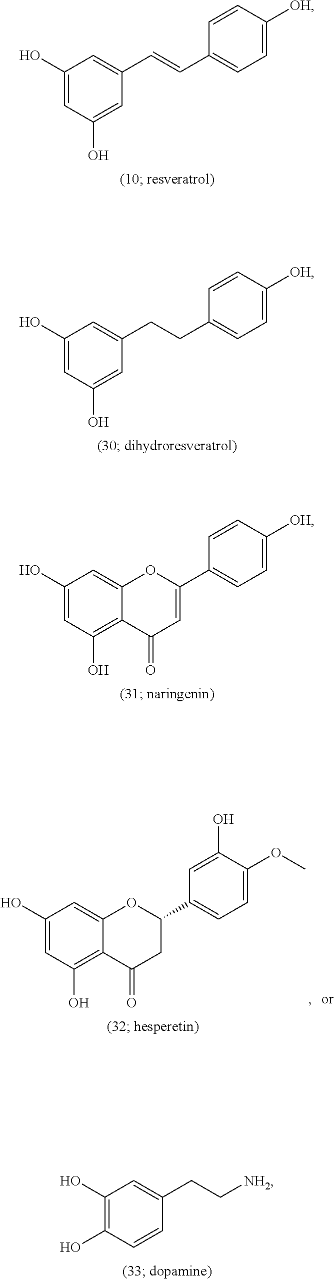 [SMILES: Oc1ccc(/C=C/c2cc(O)cc(O)c2)cc1 ; Oc1ccc(CCc2cc(O)cc(O)c2)cc1 ; O=c1cc(-c2ccc(O)cc2)oc2cc(O)cc(O)c12 ; COc1ccc([C@@H]2CC(=O)c3c(O)cc(O)cc3O2)cc1O ; NCCc1ccc(O)c(O)c1]

or a tautomer, isotopically labeled compound, salt, solvate, polymorph, or co-crystal thereof.

In certain embodiments, the molecular weight of at least one (e.g., each) type of the phenols is between 110 and 200, between 200 and 300, between 300 and 400, or between 400 and 600, g/mol.

In certain embodiments, the number of types of the phenols is one. In certain embodiments, the number of types of the phenols is two.

In certain embodiments, each type of the phenols is substantially free of water.

In certain embodiments, at least one (e.g., each) type of the isocyanates is a diisocyanate, wherein each of the diisocyanates is independently a compound comprising two instances of —NCO and zero instances of each of —OH, —NH₂, and —NH—.

In certain embodiments, at least one (e.g., each) type of the isocyanates is of the formula:

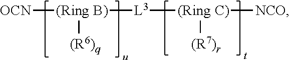

or a tautomer, isotopically labeled compound, salt, solvate, polymorph, or co-crystal thereof, wherein:
each instance of u is independently 0 or 1;
each instance of Ring B is independently aryl, heteroaryl, carbocyclyl, or heterocyclyl;
each instance of R⁶ is independently halogen, substituted or unsubstituted alkyl, —O-(substituted or unsubstituted alkyl), —O-(substituted or unsubstituted aryl), or —O-(oxygen protecting group);
each instance of q is independently 0, 1, 2, 3, or 4, as valency permits;
each instance of L³ is independently substituted or unsubstituted alkylene, substituted or unsubstituted alkenylene, substituted or unsubstituted alkynylene, substituted or unsubstituted heteroalkylene, substituted or unsubstituted heteroalkenylene, or substituted or unsubstituted heteroalkynylene, wherein zero or more (e.g., one or two) backbone carbon atoms of the alkylene, alkenylene, alkynylene, heteroalkylene, heteroalkenylene, or heteroalkynylene are independently replaced with substituted or unsubstituted arylene, substituted or unsubstituted heteroarylene, substituted or unsubstituted carbocyclylene, or substituted or unsubstituted heterocyclylene, or a combination thereof, as valency permits; or a single bond when at least one (e.g., each) of u and t is 1;
each instance of t is independently 0 or 1;
each instance of Ring C is independently aryl, heteroaryl, carbocyclyl, or heterocyclyl;
each instance of R⁷ is independently halogen, substituted or unsubstituted alkyl, —O-(substituted or unsubstituted alkyl), —O-(substituted or unsubstituted aryl), or —O-(oxygen protecting group); and
each instance of r is independently 0, 1, 2, 3, or 4, as valency permits.

In certain embodiments, at least one (e.g., each) instance of u is 0. In certain embodiments, at least one (e.g., each) instance of u is 1.

In certain embodiments, at least one (e.g., each) instance of Ring B is independently phenyl or cyclohexyl. In certain embodiments, at least one (e.g., each) instance of Ring B is independently monocyclic, 4- to 8-membered carbocyclyl.

In certain embodiments, at least one (e.g., each) instance of R⁶ is independently halogen, unsubstituted alkyl, or —O-(unsubstituted alkyl).

In certain embodiments, at least one (e.g., each) instance of q is 0. In certain embodiments, at least one (e.g., each) instance of q is 1.

In certain embodiments, at least one (e.g., each) instance of t is 0. In certain embodiments, at least one (e.g., each) instance of t is 1.

In certain embodiments, at least one (e.g., each) instance of Ring C is independently phenyl or cyclohexyl. In certain embodiments, at least one (e.g., each) instance of Ring C is independently monocyclic, 4- to 8-membered carbocyclyl.

In certain embodiments, at least one (e.g., each) instance of R⁷ is independently halogen, unsubstituted alkyl, or —O-(unsubstituted alkyl).

In certain embodiments, at least one (e.g., each) instance of r is 0. In certain embodiments, at least one (e.g., each) instance of r is 1.

In certain embodiments, at least one (e.g., each) type of the isocyanates is of the formula:

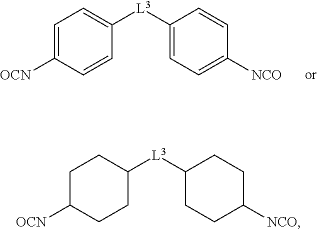

or a tautomer, isotopically labeled compound, salt, solvate, polymorph, or co-crystal thereof.

In certain embodiments, at least one (e.g., each) instance of L³ is a single bond. In certain embodiments, at least one (e.g., each) instance of L³ is substituted or unsubstituted alkylene or substituted or unsubstituted heteroalkylene, wherein zero or more (e.g., one or two) backbone carbon atoms of the alkylene or heteroalkylene are replaced with substituted or unsubstituted heterocyclylene, as valency permits. In certain embodiments, at least one (e.g., each) instance of L³ is substituted or unsubstituted alkylene. In certain embodiments, at least one (e.g., each) instance of L³ is —CH₂—, —(CH₂)₂—, —(CH₂)₃—, —(CH₂)₄—, —(CH₂)₅—, or —(CH₂)₆—.

In certain embodiments, at least one (e.g., each) type of the isocyanates is of the formula:

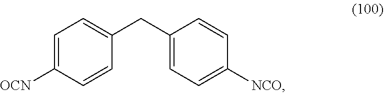

or a tautomer, isotopically labeled compound, solvate, polymorph, or co-crystal thereof.

In certain embodiments, at least one (e.g. each) type of the isocyanates is of the formula:

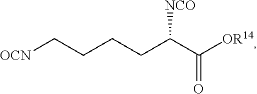

or a tautomer, isotopically labeled compound, solvate, polymorph, or co-crystal thereof, wherein each instance of R¹⁴ is H, substituted or unsubstituted alkyl, substituted or unsubstituted aryl, or an oxygen protecting group. In certain embodiments, at least one (e.g., each) instance of R¹⁴ is unsubstituted alkyl (e.g., unsubstituted C₁₋₃ alkyl).

In certain embodiments, at least one (e.g., each) type of the isocyanates is of the formula:

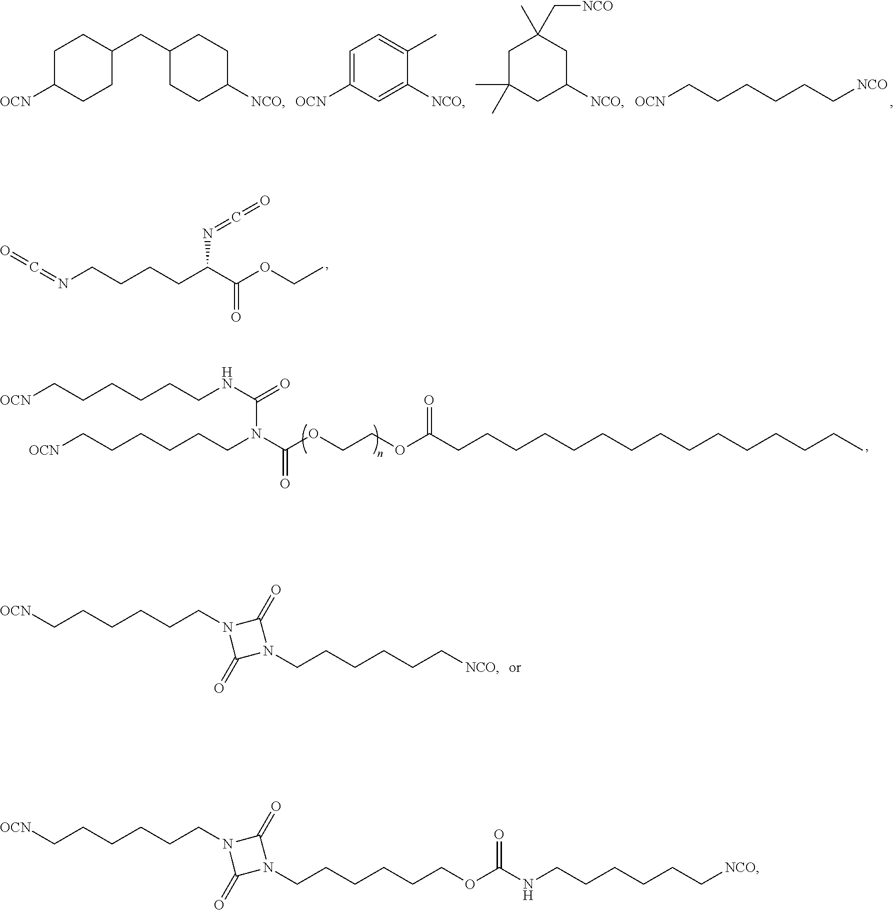

or a tautomer, isotopically labeled compound, solvate, polymorph, or co-crystal thereof.

In certain embodiments, at least one (e.g., each) type of the isocyanates is a polyisocyanate. In certain embodiments, a polyisocyanate is a compound comprising three or more (e.g., four) instances of —NCO and zero instances of each of —OH, —NH₂, and —NH—. In certain embodiments, at least one (e.g., each) type of the isocyanates is a Desmodur® polyisocyanate (e.g., a Desmodur® aliphatic polyisocyanate, e.g., Desmodur® N 3200, Desmodur® N 3300, Desmodur® N 3400, Desmodur® N 3500, Desmodur® N 3600, Desmodur® N 3700, Desmodur® N 3800, Desmodur® N 3900, Desmodur® N 31000, or DesmodurR N 31100, or a mixture thereof).

In certain embodiments, at least one (e.g., each) type of the isocyanates is of the formula:

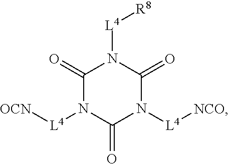

or a tautomer, isotopically labeled compound, salt, solvate, polymorph, or co-crystal thereof, wherein:
each instance of L⁴ is independently substituted or unsubstituted alkylene, substituted or unsubstituted alkenylene, substituted or unsubstituted alkynylene, substituted or unsubstituted heteroalkylene, substituted or unsubstituted heteroalkenylene, or substituted or unsubstituted heteroalkynylene, wherein zero or more (e.g., one or two) backbone carbon atoms of the alkylene, alkenylene, alkynylene, heteroalkylene, heteroalkenylene, or heteroalkynylene are independently replaced with substituted or unsubstituted arylene, substituted or unsubstituted heteroarylene, substituted or unsubstituted carbocyclylene, or substituted or unsubstituted heterocyclylene, or a combination thereof, as valency permits; and
each instance of R⁸ is independently hydrogen or —NCO.

In certain embodiments, at least one (e.g., each) type of the isocyanates is a triisocyanate, wherein each of the triisocyanates is independently a compound comprising three instances of —NCO and zero instances of each of —OH, —NH₂, and —NH—.

In certain embodiments, at least one (e.g., each) instance of R⁸ is —NCO.

In certain embodiments, at least one (e.g., each) instance of L⁴ is substituted or unsubstituted alkylene or substituted or unsubstituted heteroalkylene, wherein zero or more (e.g., one or two) backbone carbon atoms of the alkylene or heteroalkylene are replaced with substituted or unsubstituted heterocyclylene, as valency permits. In certain embodiments, at least one (e.g., each) instance of L⁴ is substituted or unsubstituted alkylene (e.g., unsubstituted unbranched C₂₋₁₂ alkylene). In certain embodiments, at least one (e.g., each) instance of L⁴ is —CH₂—, —(CH₂)₂—, —(CH₂)₃—, —(CH₂)₄—, —(CH₂)₅—, —(CH₂)₆—, —(CH₂)₇—, or —(CH₂)₈—.

In certain embodiments, at least one (e.g., each) type of the isocyanates is of the formula:

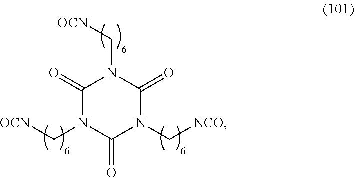

or a tautomer, isotopically labeled compound, solvate, polymorph, or co-crystal thereof.

In certain embodiments, at least one (e.g., each) type of the isocyanates is of the formula:

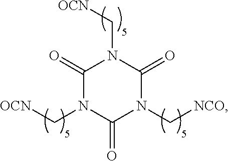

or a tautomer, isotopically labeled compound, solvate, polymorph, or co-crystal thereof.

In certain embodiments, the molecular weight of at least one (e.g., each) type of the isocyanates is between 100 and 200, between 200 and 300, between 300 and 400, or between 400 and 600, g/mol.

In certain embodiments, the number of types of the isocyanates is one. In certain embodiments, the number of types of the isocyanates is two.

In certain embodiments, each type of the isocyanates is substantially free of water. In certain embodiments, each type of the isocyanates is independently between 90% and 95%, between 95% and 97%, between 97% and 99%, between 99% and 99.5%, or between 99.5% and 99.9%, free of water.

In certain embodiments, the equivalent ratio of all types of the polyols to all types of the isocyanates is between 0.037:1 and 0.33:1, e.g., between 0.074:1 and 0.17:1. In certain embodiments, the equivalent ratio of all types of the polyols to all types of the isocyanates is between 0.037:1 and 0.074:1 or between 0.17:1 and 0.33:1. In certain embodiments, the equivalent ratio of all types of the polyols to all types of the isocyanates is between 0.15:1 and 0.8:1, e.g., between 0.15:1 and 0.3:1. In certain embodiments, the equivalent ratio of all types of the polyols to all types of the isocyanates is between 0.3:1 and 0.5:1 or between 0.5:1 and 0.8:1.

A polymer with excess amount of all types of isocyanates may show increased strength while still maintaining the debonding characteristics. In certain embodiments, the equivalent ratio of the combination of all types of the diols and all types of the polyols to all types of the isocyanates is between 0.3:1 and 0.8:1, e.g., between 0.6:1 and 0.7:1. In certain embodiments, the equivalent ratio of the combination of all types of the diols and all types of the polyols to all types of the isocyanates is between 0.3:1 and 0.4:1, between 0.4:1 and 0.5:1, between 0.5:1 and 0.6:1, or between 0.7:1 and 0.8:1. In certain embodiments, the equivalent ratio of the combination of all types of the diols and all types of the polyols to all types of the isocyanates is between 0.8:1 and 1.1:1, e.g., between 0.9:1 and 1:1. In certain embodiments, the equivalent ratio of the combination of all types of the diols and all types of the polyols to all types of the isocyanates is between 0.8:1 and 0.85:1, between 0.85:1 and 0.9:1, between 0.9:1 and 0.95:1, or between 0.95:1 and 1:1. In certain embodiments, the equivalent ratio of the combination of all types of the diols and all types of the polyols to all types of the isocyanates is between 1:1 and 1.1:1.

In certain embodiments, the equivalent ratio of all types of the diols to all types of the polyols to all types of the isocyanates is about 3:1.5:4.75-5. In certain embodiments, the equivalent ratio of all types of the diols to all types of the polyols to all types of the isocyanates is about 3:1.5:4.75. In certain embodiments, the equivalent ratio of all types of the diols to all types of the polyols to all types of the isocyanates is about 3:1.5:5.

In certain embodiments, the polymerization mixture further comprises a polymerization catalyst (e.g., catalyst for preparing polymers). In certain embodiments, the polymerization mixture of the one-step method further comprises a polymerization catalyst. In certain embodiments, the polymerization mixture of the two-step method is substantially free (e.g., between 90% and 95%, between 95% and 97%, between 97% and 99%, between 99% and 99.5%, or between 99.5% and 99.9%, free) of a polymerization catalyst. In certain embodiments, the polymerization catalyst is an organometallic catalyst for preparing polymers. In certain embodiments, the polymerization catalyst is an organometallic catalyst comprising Sn(II), Sn(IV), Na(I), K(I), Ca(II), or Fe(III). In certain embodiments, the polymerization catalyst is dibutyltin dilaurate, dibutyltin mercaptide, dibutyltin thiocarboxylate, tin(II) 2-ethylhexanoate, sodium carbonate, sodium bicarbonate, potassium carbonate, potassium bicarbonate, calcium carbonate, calcium bicarbonate, tris(acetylacetonato)iron(III), triethylenediamine, 1,4-diazabicyclo[2.2.2]octane, dimethylcyclohexylamine, dimethylethanolamine, or bis-(2-dimethylaminoethyl)ether, or a salt, solvate, polymorph, or co-crystal thereof, or a mixture thereof.

In certain embodiments, the weight ratio of the polymerization catalyst to the combination of: all types of the diols, all types of the polyols, and all types of the isocyanates is between 0.003:1 and 0.03:1, e.g., between 0.005:1 and 0.02:1. In certain embodiments, the weight ratio of the polymerization catalyst to the combination of: all types of the diols, all types of the polyols, and all types of the isocyanates is between 0.001:1 and 0.003:1, between 0.003:1 and 0.01:1, between 0.01:1 and 0.03:1, or between 0.03:1 and 0.1:1.

In certain embodiments, the polymerization mixture further comprises a solvent. In certain embodiments, the solvent is substantially one single solvent. In certain embodiments, the solvent is a mixture of two or more (e.g., three) solvents (e.g., solvents described in this paragraph). In certain embodiments, the solvent is an organic solvent. In certain embodiments, the solvent is a non-aromatic organic solvent. In certain embodiments, the solvent is acetone. In certain embodiments, the solvent is methyl ethyl ketone. In certain embodiments, the solvent is a mixture of acetone and methyl ethyl ketone. In certain embodiments, the solvent is a mixture of acetone and methyl ethyl ketone, wherein the volume ratio of acetone to methyl ethyl ketone is between 1:9 and 9:1, e.g., between 1:2 and 2:1. In certain embodiments, the solvent is a mixture of acetone and methyl ethyl ketone, wherein the volume ratio of acetone to methyl ethyl ketone is between 1:1.5 and 1.5:1, between 1:3 and 3:1, or between 1:5 and 5:1. In certain embodiments, the solvent is a mixture of acetone and methyl isopropyl ketone. In certain embodiments, the solvent is a mixture of acetone and 2-pentanone. In certain embodiments, the solvent is a mixture of acetone and 3-pentanone. In certain embodiments, the solvent is acetonitrile, dioxane, tetrahydrofuran, methyl tert-butyl ether, or 2-methyltetrahydrofuran, or a mixture thereof. In certain embodiments, the solvent is N,N-dimethylacetamide. In certain embodiments, the solvent is substantially free (e.g., between 90% and 95%, between 95% and 97%, between 97% and 99%, between 99% and 99.5%, or between 99.5% and 99.9%, free) of N,N-dimethylacetamide. In certain embodiments, the boiling point of the solvent at 1 atm is between 50 and 60, between 60 and 70, between 70 and 80, between 80 and 90, between 90 and 100, or between 100 and 120° C. (e.g., between 5° and 90° C.). The solvent may be adjusted to improve film quality and prevent bubbles during solvent flash at elevated temperature during drying.

In certain embodiments, the solvent is substantially free of water. In certain embodiments, the polymerization mixture is substantially free of water. In certain embodiments, the solvent is substantially free of dioxygen. In certain embodiments, the polymerization mixture is substantially free of dioxygen. In certain embodiments, the solvent is substantially free of water and dioxygen. In certain embodiments, the polymerization mixture is substantially free of water and dioxygen. In certain embodiments, each substantially free of dioxygen is independently between 90% and 95%, between 95% and 97%, between 97% and 99%, between 99% and 99.5%, or between 99.5% and 99.9%, free of dioxygen. In certain embodiments, the polymerization mixture is under an inert atmosphere.

In certain embodiments, the ratio of the combined weight of all types of diols, all types of polyols, and all types of isocyanates to the volume of the solvent is about 1:0.7 g/ml. In certain embodiments, the ratio of the combined weight of all types of diols, all types of polyols, and all types of isocyanates to the volume of the solvent is between 1:0.3 and 1:10 g/ml. In certain embodiments, the ratio of the combined weight of all types of diols, all types of polyols, and all types of isocyanates to the volume of the solvent is between 1:0.1 and 1:0.3, between 1:0.3 and 1:0.7, between 1:0.7 and 1:1, between 1:1 and 1:2, between 1:2 and 1:3, between 1:3 and 1:5, between 1:5 and 1:10, between 1:10 and 1:20, or between 1:20 and 1:40, g/ml.

Unless otherwise provided, any of the mixtures and steps is under a pressure between 0.5 and 1.1 atm (e.g., between 0.8 and 1.1 atm).

In certain embodiments, the polymerization mixture is prepared by a method (“one-step method”) comprising reacting a first mixture comprising one or more types of diols, one or more types of isocyanates, and one or more types of polyols at a sixth temperature for a sixth time duration.

In certain embodiments, the polymerization mixture is prepared by a method (“two-step method”) comprising:
reacting a first mixture comprising one or more types of diols and one or more types of isocyanates at a sixth temperature for a sixth time duration; and
mixing the first mixture, one or more types of diols, and one or more types of polyols.

The two-step method may be advantageous over the one-step method at least because the polymers prepared by the former may show higher strength than the polymers prepared by the latter.

In certain embodiments, at least one type of the diols of the first mixture is the same as at least one type of the diols of the step of mixing. In certain embodiments, at least one type of the diols of the first mixture is different from at least one type of the diols of the step of mixing.

In certain embodiments, the first mixture is substantially free (e.g., between 90% and 95%, between 95% and 97%, between 97% and 99%, between 99% and 99.5%, or between 99.5% and 99.9%, free) of a solvent. In certain embodiments, the first mixture further comprises a solvent.

In certain embodiments, the first mixture is substantially free of water and dioxygen. In certain embodiments, the first mixture is substantially free of water. In certain embodiments, the first mixture is substantially free of dioxygen. In certain embodiments, the first mixture is under an inert atmosphere.

In certain embodiments, the sixth temperature is between 40 and 60, between 60 and 80, between 80 and 100, between 100 and 120, or between 12° and 140° C., e.g., between 9° and 110° C.

In certain embodiments, the sixth time duration is between 10 minutes and 1 hour, between 1 and 3 hours, between 3 and 8 hours, between 8 and 24 hours, or between 1 and 3 days, e.g., between 0.5 and 4 hours.

In certain embodiments, the method further comprises cooling the first mixture to between 2° and 30° C., wherein the step of cooling is subsequent to the step of reacting and prior to the step of mixing.

In certain embodiments, the method further comprises curing the polymerization mixture at a seventh temperature for a seventh time duration.

In certain embodiments, the seventh temperature is between 30 and 40, between 40 and 50, between 50 and 60, between 60 and 70, or between 7° and 80° C., e.g., between 4° and 60° C.

In certain embodiments, the seventh time duration is between 1 and 3 hours, between 3 and 8 hours, between 8 and 24 hours, or between 1 and 3 days, e.g., between 6 and 24 hours.

In certain embodiments, the step of removing comprises an eighth temperature, an eighth pressure, and an eighth time duration.

In certain embodiments, the eighth temperature is between 30 and 40, between 40 and 50, between 50 and 60, between 60 and 80, or between 8° and 100° C., e.g., between 5° and 80° C.

In certain embodiments, the eighth pressure is between 10⁻⁷ and 10⁻⁶, between 10⁻⁶ and 10⁻⁵, between 10⁻⁵ and 10⁻⁴, between 10⁻⁴ and 10⁻³, or between 10⁻³ and 10⁻² atm, e.g., between 10⁻⁶ and 10⁻⁴ atm.

In certain embodiments, the eighth time duration is between 1 and 3 hours, between 3 and 8 hours, between 8 and 24 hours, between 1 and 3 days, or between 3 and 7 days, e.g., between 12 and 48 hours.

In certain embodiments, the method comprising reacting the polymerization mixture and the method of preparing a polymer further comprise removing substantially all the solvent. In certain embodiments, the step of removing substantially all the solvent comprises evaporating substantially all the solvent under reduced pressure at a temperature of between 50 and 60, between 60 and 70, between 70 and 80, or between 8° and 90° C., for a time duration of between 1 and 8 hours, between 8 and 24 hours, between 1 and 3 days, between 3 and 7 days, or between 7 and 14 days. In certain embodiments, the reduced pressure is between 0.001 and 0.01, between 0.01 and 0.1, or between 0.1 and 1 atm. In certain embodiments, substantially all the solvent is between 90% and 95%, between 95% and 97%, between 97% and 99%, between 99% and 99.5%, or between 99.5% and 99.9% of the solvent.

In certain embodiments, the diols, polyols, and isocyanates are:

| Polymer | | | |
|---|---|---|---|
| number | Diol | Polyol | Isocyanate |
| 1-5 | 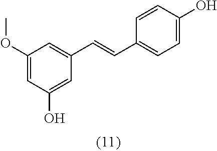 [SMILES: COc1cc(O)cc(/C=C/c2ccc(O)cc2)c1] | 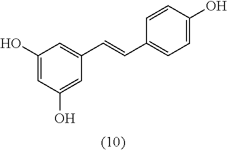 [SMILES: Oc1ccc(/C=C/c2cc(O)cc(O)c2)cc1] | 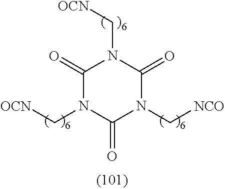 |
| 1-11 | 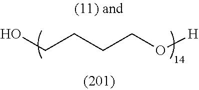 | Glycerol | 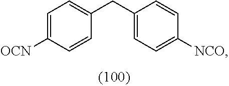 |

or a tautomer, isotopically labeled compound, salt, solvate, polymorph, or co-crystal thereof.

In certain embodiments, the diols, polyols, and isocyanates, and the equivalents thereof, are:

| | | | | Molar ratio of combined |
|---|---|---|---|---|
| | | | | equivalents of diol and |
| Polymer | | | Isocyanate/ | polyol to equivalent of |
| number | Diol/Equivalent | Polyol/Equivalent | Equivalent | isocyanate |
| 1-5A | (11)/0.84 ± 10% | (10)/0.11 ± 10% | (101)/1 | 49 ± 2%:51 ± 2% |
| 1-11A | (11)/0.42 ± 10% | Glycerol/0.11 ± 10% | (100)/1 | 49 ± 2%:51 ± 2% |
| | and | | | |
| | (201)/0.42 ± 10% | | | |

or a tautomer, isotopically labeled compound, salt, solvate, polymorph, or co-crystal thereof.

In certain embodiments, the polymer is a polyurethane, polyurea, polyurethaneurea, or a combination (e.g., blend) thereof. In certain embodiments, the polymer is a polyurethane. In certain embodiments, the polymer is a polyurea. In certain embodiments, the polymer is a polyurethaneurea. In certain embodiments, the polymer is a combination of a polyurethane and a polyurea. In certain embodiments, the polymer is a combination of a polyurethane and a polyurethaneurea. In certain embodiments, the polymer is a combination of a polyurea and a polyurethaneurea. In certain embodiments, the polymer is a combination of a polyurethane, a polyurea, a polyurethaneurea.

In certain embodiments, the number average molecular weight of the polymer is between 5,000 and 10,000, between 10,000 and 30,000, between 30,000 and 100,000, between 100,000 and 300,000, or between 300,000 and 1,000,000, g/mol.

In certain embodiments, the dispersity of the polymer is between 1.0 and 1.5, between 1.5 and 2.0, between 2.0 and 2.5, or between 2.5 and 3.0.

In certain embodiments, the average crosslinking degree of the polymer is between 10% and 20%, between 20% and 30%, between 30% and 40%, between 40% and 50%, or between 50% and 60%, mole:mole. In certain embodiments, the average crosslinking degree is determined by swelling measurements.

In certain embodiments, the polymer is crosslinked. In certain embodiments, the polymer is a thermoset. In certain embodiments, the polymer is capable of undergoing a reversable transition from a cross-linked state to a lightly cross-linked or un-crosslinked state. In certain embodiments, the polymer is capable of undergoing a reversable transition from a thermoset state to a thermoplastic state.

In certain embodiments, the polymer is with a transition temperature between 50 and 170° C., e.g., between 6° and 160° C., e.g., between 7° and 150° C. In certain embodiments, the polymer is with a transition temperature between 50 and 60, between 60 and 70, between 70 and 80, between 80 and 100, between 100 and 120, between 120 and 140, or between 14° and 160° C.

In certain embodiments, the viscosity of the polymer at 10° C. above the transition temperature is between 1 cP and 250,000 cP, between 100 cP and 75,000 cP, or between 1000 cP and 20,000 cP. In certain embodiments, the viscosity of the polymer at 10° C. above the transition temperature is between 1 and 10, between 10 and 100, between 100 and 1,000, between 1,000 and 10,000, or between 10,000 and 100,000 cP.

In certain embodiments, the polymer is transparent (e.g., having a total transmittance of between 80% and 85%, between 85% and 90%, between 90% and 95%, between 95% and 99%, or between 99% and 99.9%.) under American Society for Testing and Materials (ASTM) Standard D 1746.

In another aspect, the present disclosure provides compositions comprising the polymer. In certain embodiments, the composition further comprises one or more excipients. In certain embodiments, the composition further comprises one or more adhesion promoters, one or more fillers, and/or one or more rheology modifiers.

Adhesion promoters may facilitate bonding among the components of the composition and/or between the composition and a surface of a solid substrate. In certain embodiments, the adhesion promoter is a silane compound (e.g., N-ethylaminoisobutyl trimethoxysilane, tris(3-(trimethoxysilyl)propyl)-isocyanurate, 3-aminopropyltriethoxysilane, 3-isocyanatopropyl trimethoxysilane, 3-isocyanatopropyl triethoxysilane, or 3-glycidoxypropylmethyldiethoxysilanem, or a mixture thereof).

Fillers may be used to adjust the density and/or viscosity of the composition. In certain embodiments, the filler is a fine particle filler (e.g., a clay, polysilica, highly dispersed, pyrogenic, hydrophilic silica, montmorillonite, kaolinite, halloysite, aluminum hydroxide, aluminum oxide hydrate, aluminum silicate, talc, quartz mineral, chalk, magnesium hydroxide, molecular sieves, mica, calcium carbonate, kaolin, titanium oxide, diatomaceous earth, urea-based resin, styrene beads, calcined clay, or starch, or a mixture thereof).

In certain embodiments, the rheology modifier is a clay, gum, cellulosic, hydrophobically modified ethoxylated urethane, surfactant gel, polyester, or polysaccharide (e.g., chitin), or a mixture thereof.

In another aspect, the present disclosure provides kit comprising the polymer or the composition; and instructions for using the polymer or composition. In certain embodiments, the kit comprises a first container, wherein the first container comprises the polymer or the composition. In some embodiments, the kit further comprises a second container. In certain embodiments, the second container comprises the one or more excipients, one or more adhesion promoters, one or more fillers, and/or one or more rheology modifiers. In certain embodiments, the second container comprises the instructions. In certain embodiments, each of the first and second containers is independently a vial, ampule, bottle, syringe, dispenser package, tube, or box.

In certain embodiments, the polymer or composition is in the form of a film (e.g., die cut film), powder, pellet, solid, rod, cylinder, or tube (e.g., die cut tube). In certain embodiments, the polymer or composition is in the form of a film, wherein the average thickness of the film is between 0.001 and 1 mm, e.g., between 0.15 and 0.5 mm. In certain embodiments, the polymer or composition is in the form of a film, wherein the average thickness of the film is between 0.001 and 0.01 mm, between 0.01 and 0.05 mm, between 0.05 and 0.1, between 0.1 and 0.2, between 0.2 and 0.4, between 0.4 and 0.7, or between 0.7 and 1 mm.

In certain embodiments, the polymer or composition is capable of bonding to a solid substrate below the transition temperature of the polymer.

In certain embodiments, the polymer or composition is capable of, after bonding to the solid substrate, reversable de-bonding from the solid substrate at or above the transition temperature of the polymer.

In certain embodiments, the polymer or composition is suitable for use as a hot melt adhesive.

In another aspect, the present disclosure provides methods of bonding comprising:
applying the polymer or composition to a surface of a first solid substrate; contacting the polymer or composition on the surface of the first solid substrate with a surface of a second solid substrate; and curing the polymer or composition on the surface of the first solid substrate to form bonded first and second substrates; or
applying the polymer or composition to a surface of a first solid substrate and a surface of a second solid substrate; contacting the polymer or composition on the surface of the first solid substrate with the polymer or composition on the surface of the second solid substrate; and curing the polymer or composition on the surface of the first solid substrate and the polymer or composition on the surface of the second solid substrate to form bonded first and second substrates;
wherein the first solid substrate is the same or different from the second solid substrate.

In certain embodiments, at least one (e.g., each) surface is an outer surface. In certain embodiments, at least one (e.g., each) surface is an inner surface.

In certain embodiments, the methods further comprise heating the polymer or composition to a second temperature, wherein: the polymer or composition are flowable at the second temperature, and the step of heating the polymer or composition to a second temperature occurs:
prior to the step of applying the polymer or composition;
subsequent to the step of applying the polymer or composition and prior to the step of contacting the polymer or composition; or
subsequent to the step of contacting the polymer or composition and prior to the step of curing the polymer or composition.

In certain embodiments, the second temperature is between 5° and 170° C., e.g., between 6° and 160° C., e.g., between 7° and 150° C. In certain embodiments, the second temperature is between 50 and 60, between 60 and 70, between 70 and 80, between 80 and 100, between 100 and 120, between 120 and 140, or between 14° and 160° C. In certain embodiments, the second temperature is between 100% and 110%, between 110% and 120%, between 120% and 130%, between 130% and 150%, between 150% and 170%, or between 170% and 200% of the transition temperature.

In certain embodiments, the step of applying the polymer or composition is substantially free of water. In certain embodiments, the step of contacting the polymer or composition is substantially free of water. In certain embodiments, the step of curing the polymer or composition is substantially free of water.

In certain embodiments, the step of curing the polymer or composition comprises:
maintaining the polymer or composition at a third temperature for a third time duration, wherein the third temperature is between 5° and 220° C.; and
maintaining the polymer or composition at a fourth temperature for a fourth time duration, wherein the fourth temperature is between 2° and 30° C.

In certain embodiments, the third temperature is between 5° and 170° C., e.g., between 6° and 160° C., e.g., between 7° and 150° C. In certain embodiments, the third temperature is between 50 and 60, between 60 and 70, between 70 and 80, between 80 and 100, between 100 and 120, between 120 and 140, or between 14° and 160° C. In certain embodiments, the third temperature is between 100 and 120, between 120 and 140, between 140 and 160, between 160 and 180, between 180 and 200, or between 20° and 220° C., e.g., between 13° and 200° C. In certain embodiments, the third temperature is between 100% and 110%, between 110% and 120%, between 120% and 130%, between 130% and 150%, between 150% and 170%, or between 170% and 200% of the transition temperature.

In certain embodiments, the third time duration is between 5 and 20 minutes, between 20 minutes and 1 hour, between 1 and 3 hours, between 3 and 8 hours, or between 8 and 24 hours, e.g., between 10 minutes and 8 hours.

In certain embodiments, the third temperature is between 13° and 150° C., and the third time duration is between 2 and 8 hours. In certain embodiments, the third temperature is between 15° and 200° C., and the third time duration is between 10 minutes and 3 hours.

In certain embodiments, the fourth temperature is between 2° and 24° C.

In certain embodiments, the fourth time duration is between 10 minute and 1 hour, between 1 and 8 hours, between 8 and 24 hours, between 1 and 3 days, between 3 and 7 days, between 7 and 14 days, or between 14 to 30 days, e.g., between 3 and 14 days, e.g., between 30 minutes and 4 days. In certain embodiments, the fourth time duration is between 30 minute and 2 hours.

In another aspect, the present disclosure provides methods of de-bonding comprising maintaining the bonded first and second substrates at a fifth temperature for a fifth time duration sufficient to form de-bonded first and solid substrates, wherein:
the fifth temperature is between 40 and 60, between 60 and 80, between 80 and 100, between 100 and 120, between 120 and 140, between 140 and 160, between 160 and 180, or between 18° and 200° C., e.g., between 5° and 150° C.; and
the fifth time duration is between 10 and 60 seconds, between 1 and 10 minutes, between 10 and 60 minutes, between 1 and 8 hours, or between 8 and 24 hours, e.g., between 10 seconds and 2 minutes.

In certain embodiments, the solid substrate is a metal (e.g., metal alloy, anodized metal, or metal oxide), glass, ceramic, composite, plastic (e.g., filled plastic or blend of plastic), or wood. In certain embodiments, the solid substrate is stainless steel, aluminum, anodized aluminum, aluminum alloy, or anodized aluminum alloy. In certain embodiments, the solid substrate is acrylonitrile butadiene styrene, polycarbonate, polycarbonate siloxane copolymer, polyamide, or polybutylene terephthalate. In certain embodiments, the solid substrate is polyamide 66, polyamide 6, polyamide 510, or polyamide 1,6. In certain embodiments, the solid substrate is a glass fiber filled polymer, e.g., glass fiber filled polyamide or glass fiber filled polybutylene terephthalate. In certain embodiments, the solid substrate is polymer blend, e.g., polycarbonate-polybutylene terephthalate blend. In certain embodiments, the solid substrate is a textile (e.g., textile bonded to plastic), leather, paper, or cardboard.

In certain embodiments, the solid substrate is part of: an electronic device, soft goods, aircraft, vehicle, civil engineering structure, or building. In certain embodiments, the electronic device is a phone (e.g., mobile phone), computer (e.g., laptop computer or tablet computer), watch, keyboard, or display, or a component thereof (e.g., phone cover or watch strap).

### EQUIVALENTS AND SCOPE

In the claims articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention includes embodiments in which more than one, or all of the group members are present in, employed in, or otherwise relevant to a given product or process.

Furthermore, the invention encompasses all variations, combinations, and permutations in which one or more limitations, elements, clauses, and descriptive terms from one or more of the listed claims is introduced into another claim. For example, any claim that is dependent on another claim can be modified to include one or more limitations found in any other claim that is dependent on the same base claim. Where elements are presented as lists, e.g., in Markush group format, each subgroup of the elements is also disclosed, and any element(s) can be removed from the group. It should it be understood that, in general, where the invention, or aspects of the invention, is/are referred to as comprising particular elements and/or features, certain embodiments of the invention or aspects of the invention consist, or consist essentially of, such elements and/or features. For purposes of simplicity, those embodiments have not been specifically set forth in haec verba herein. It is also noted that the terms “comprising,” “including,” and “containing,” and all other tenses thereof, are intended to be open and permits the inclusion of additional possibilities (e.g., elements or steps). Where ranges are given, endpoints are included. Furthermore, unless otherwise indicated or otherwise evident from the context and understanding of one of ordinary skill in the art, values that are expressed as ranges can assume any specific value or sub-range within the stated ranges in different embodiments of the invention, to the tenth of the unit of the lower limit of the range, unless the context clearly dictates otherwise.

This application refers to various issued patents, published patent applications, journal articles, and other publications, all of which are incorporated herein by reference. If there is a conflict between any of the incorporated references and the instant specification, the specification shall control. In addition, any particular embodiment of the present invention that falls within the prior art may be explicitly excluded from any one or more of the claims. Because such embodiments are deemed to be known to one of ordinary skill in the art, they may be excluded even if the exclusion is not set forth explicitly herein. Any particular embodiment of the invention can be excluded from any claim, for any reason, whether or not related to the existence of prior art.

Those skilled in the art will recognize or be able to ascertain using no more than routine experimentation many equivalents to the specific embodiments described herein. The scope of the present embodiments described herein is not intended to be limited to the above Description, but rather is as set forth in the appended claims. Those of ordinary skill in the art will appreciate that various changes and modifications to this description may be made without departing from the spirit or scope of the present invention, as defined in the following claims.

1. A polymer prepared by a method comprising reacting a polymerization mixture comprising one or more types of diols, one or more types of polyols, and one or more types of isocyanates at a first temperature for a first time duration sufficient to forming the polymer, wherein:
each type of the diols is independently a compound comprising zero or more instances of C—OH, zero or more instances of —NH₂, zero or more instances of —NH—, and zero instances of each of ═N—OH and —NCO, wherein the combined number of C—OH, —NH₂, and —NH— of each of the diols is two;
each type of the polyols is independently a compound comprising zero or more instances of C—OH, zero or more instances of —NH₂, zero or more instances of —NH—, and zero instances of each of ═N—OH and —NCO, wherein the combined number of C—OH, —NH₂, and —NH— of each of the polyols is at least three;
at least one type of the diols and/or at least one type of the polyols are phenols, wherein each of the phenols is independently a diol or polyol, wherein one or more instances of —OH, —NH₂, and/or —NH— are aryl-bound; and
each type of the isocyanates is independently a compound comprising two or more instances of —NCO and zero instances of each of —OH, —NH₂, and —NH—.

2. A method of preparing a polymer comprising reacting a polymerization mixture comprising one or more types of diols, one or more types of polyols, and one or more types of isocyanates at a first temperature for a first time duration sufficient to forming the polymer, wherein:
each type of the diols is independently a compound comprising zero or more instances of C—OH, zero or more instances of —NH₂, zero or more instances of —NH—, and zero instances of each of ═N—OH and —NCO, wherein the combined number of C—OH, —NH₂, and —NH— of each of the diols is two;
each type of the polyols is independently a compound comprising zero or more instances of C—OH, zero or more instances of —NH₂, zero or more instances of —NH—, and zero instances of each of ═N—OH and —NCO, wherein the combined number of C—OH, —NH₂, and —NH— of each of the polyols is at least three;
at least one type of the diols and/or at least one type of the polyols are phenols, wherein each of the phenols is independently a diol or polyol, wherein one or more instances of —OH, —NH₂, and/or —NH— are aryl-bound; and
each type of the isocyanates is independently a compound comprising two or more instances of —NCO and zero instances of each of —OH, —NH₂, and —NH—.

3-4. (canceled)

5. The polymer of claim 1, wherein at least one type of the phenols is of the formula: 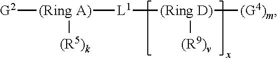
or a tautomer, isotopically labeled compound, salt, solvate, polymorph, or co-crystal thereof, wherein:
each instance of G² is independently —OH, —NH₂, or —NHR³;
each instance of R³ is independently substituted or unsubstituted alkyl, substituted or unsubstituted aryl, or a nitrogen protecting group;
each instance of Ring A is aryl;
each instance of R⁵ is independently halogen, substituted or unsubstituted alkyl, —O-(substituted or unsubstituted alkyl), —O-(substituted or unsubstituted aryl), or —O-(oxygen protecting group);
each instance of k is independently 0, 1, 2, 3, or 4, as valency permits;
each instance of L¹ is independently a single bond, substituted or unsubstituted alkylene, substituted or unsubstituted alkenylene, substituted or unsubstituted alkynylene, substituted or unsubstituted heteroalkylene, substituted or unsubstituted heteroalkenylene, or substituted or unsubstituted heteroalkynylene;
each instance of Ring D is independently aryl, heteroaryl, carbocyclyl, or heterocyclyl;
each instance of R⁹ is independently halogen, substituted or unsubstituted alkyl, —O-(substituted or unsubstituted alkyl), —O-(substituted or unsubstituted aryl), or —O-(oxygen protecting group);
each instance of v is independently 0, 1, 2, 3, or 4, as valency permits;
each instance of x is independently 0 or 1;
each instance of G⁴ is independently —OH, —NH₂, or —NHR⁴;
each instance of R⁴ is independently substituted or unsubstituted alkyl, substituted or unsubstituted aryl, or a nitrogen protecting group; and
each instance of m is independently 1, 2, 3, 4, or 5, as valency permits.

6-26. (canceled)

27. The polymer of claim 1, wherein at least one type of the phenols is of the formula: 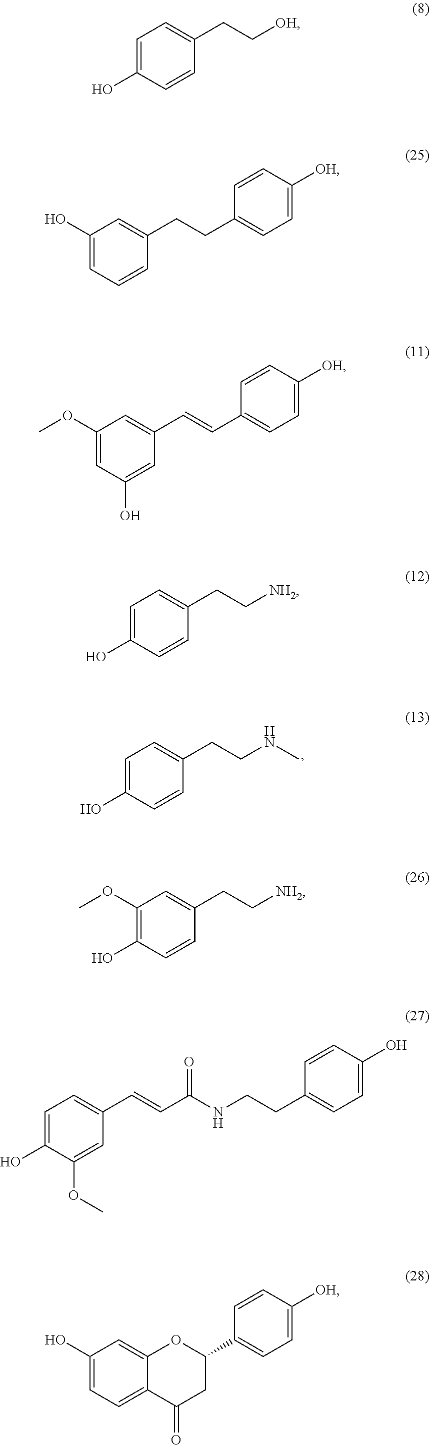 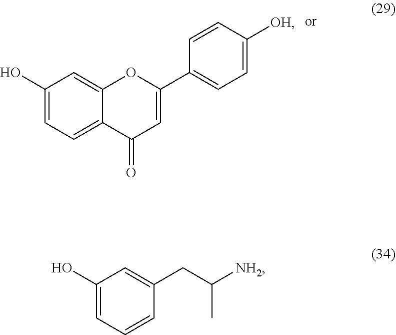 [SMILES: O=c1cc(-c2ccc(O)cc2)oc2cc(O)ccc12 ; "or" ; CC(N)Cc1cccc(O)c1]
or a tautomer, isotopically labeled compound, salt, solvate, polymorph, or co-crystal thereof.

28-32. (canceled)

33. The polymer of claim 1, wherein at least one type of the diols is of the formula: 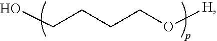
or an isotopically labeled compound thereof, wherein p is an integer between 10 and 30.

34-39. (canceled)

40. The polymer of claim 1, wherein at least one type of the polyols is of the formula: 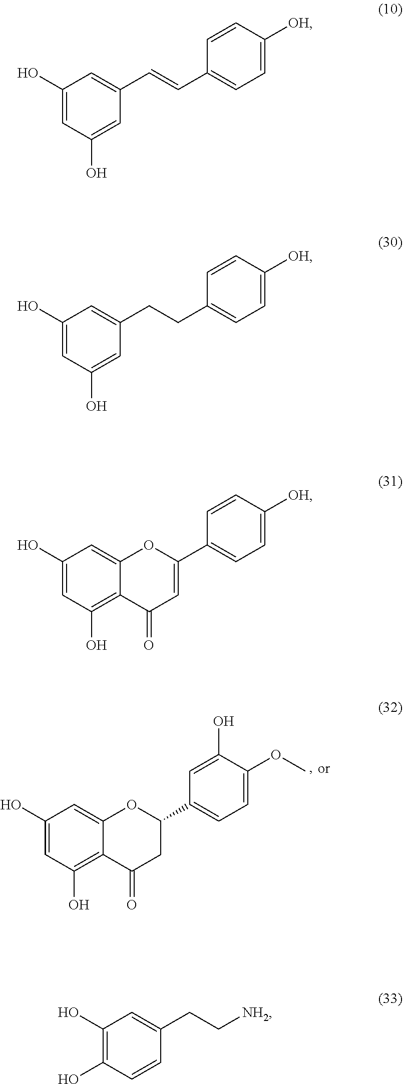 [SMILES: Oc1ccc(/C=C/c2cc(O)cc(O)c2)cc1 ; Oc1ccc(CCc2cc(O)cc(O)c2)cc1 ; O=c1cc(-c2ccc(O)cc2)oc2cc(O)cc(O)c12 ; COc1ccc([C@@H]2CC(=O)c3c(O)cc(O)cc3O2)cc1O ; NCCc1ccc(O)c(O)c1]
or a tautomer, isotopically labeled compound, salt, solvate, polymorph, or co-crystal thereof.

41-43. (canceled)

44. The polymer of claim 1, wherein at least one type of the isocyanates is of the formula: 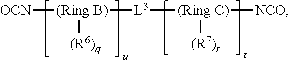
or a tautomer, isotopically labeled compound, salt, solvate, polymorph, or co-crystal thereof, wherein:
each instance of u is independently 0 or 1;
each instance of Ring B is independently aryl, heteroaryl, carbocyclyl, or heterocyclyl;
each instance of R⁶ is independently halogen, substituted or unsubstituted alkyl, —O-(substituted or unsubstituted alkyl), —O-(substituted or unsubstituted aryl), or —O-(oxygen protecting group);
each instance of q is independently 0, 1, 2, 3, or 4, as valency permits;
each instance of L³ is independently a single bond, substituted or unsubstituted alkylene, substituted or unsubstituted alkenylene, substituted or unsubstituted alkynylene, substituted or unsubstituted heteroalkylene, substituted or unsubstituted heteroalkenylene, or substituted or unsubstituted heteroalkynylene, wherein zero or more backbone carbon atoms of the alkylene, alkenylene, alkynylene, heteroalkylene, heteroalkenylene, or heteroalkynylene are independently replaced with substituted or unsubstituted arylene, substituted or unsubstituted heteroarylene, substituted or unsubstituted carbocyclylene, or substituted or unsubstituted heterocyclylene, or a combination thereof, as valency permits; or a single bond when at least one of u and t is 1;
each instance of t is independently 0 or 1;
each instance of Ring C is independently aryl, heteroaryl, carbocyclyl, or heterocyclyl;
each instance of R⁷ is independently halogen, substituted or unsubstituted alkyl, —O-(substituted or unsubstituted alkyl), —O-(substituted or unsubstituted aryl), or —O-(oxygen protecting group); and
each instance of r is independently 0, 1, 2, 3, or 4, as valency permits.

45-52. (canceled)

53. The polymer of claim 1, wherein at least one type of the isocyanates is of the formula: 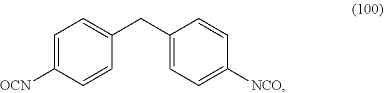
or a tautomer, isotopically labeled compound, solvate, polymorph, or co-crystal thereof.

54. The polymer of claim 1, wherein at least one type of the isocyanates is of the formula: 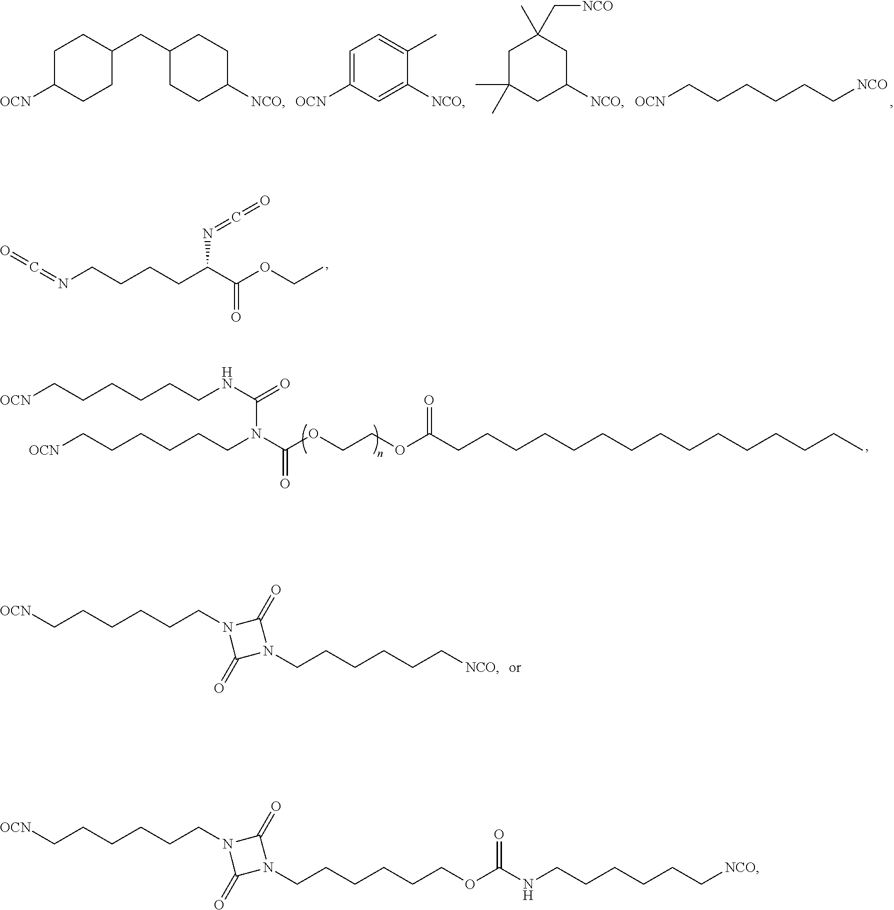
or a tautomer, isotopically labeled compound, solvate, polymorph, or co-crystal thereof.

55. The polymer of claim 1, wherein at least one type of the isocyanates is of the formula: 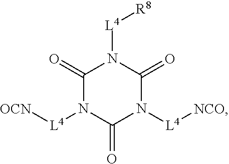
or a tautomer, isotopically labeled compound, salt, solvate, polymorph, or co-crystal thereof, wherein:
each instance of L⁴ is independently substituted or unsubstituted alkylene, substituted or unsubstituted alkenylene, substituted or unsubstituted alkynylene, substituted or unsubstituted heteroalkylene, substituted or unsubstituted heteroalkenylene, or substituted or unsubstituted heteroalkynylene, wherein zero or more backbone carbon atoms of the alkylene, alkenylene, alkynylene, heteroalkylene, heteroalkenylene, or heteroalkynylene are independently replaced with substituted or unsubstituted arylene, substituted or unsubstituted heteroarylene, substituted or unsubstituted carbocyclylene, or substituted or unsubstituted heterocyclylene, or a combination thereof, as valency permits; and
each instance of R⁸ is independently hydrogen or —NCO.

56-57. (canceled)

58. The polymer of claim 1, wherein at least one type of the isocyanates is of the formula: 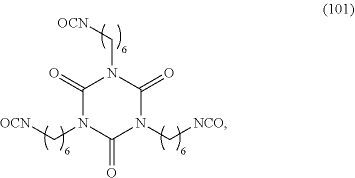
or a tautomer, isotopically labeled compound, solvate, polymorph, or co-crystal thereof.

59. The polymer of claim 1, wherein at least one type of the isocyanates is of the formula: 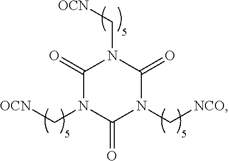
or a tautomer, isotopically labeled compound, solvate, polymorph, or co-crystal thereof.

60-92. (canceled)

93. The polymer of claim 1, wherein the diols, polyols, and isocyanates are:

| Polymer | | | |
|---|---|---|---|
| number | Diol | Polyol | Isocyanate |
| 1-5 | (11) | 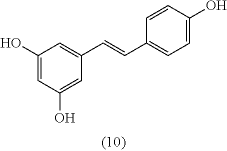 [SMILES: Oc1ccc(/C=C/c2cc(O)cc(O)c2)cc1] | (101) |
| 1-11 | (11) and | Glycerol | (100), |
| | (201) | | |

or a tautomer, isotopically labeled compound, salt, solvate, polymorph, or co-crystal thereof.

94-97. (canceled)

98. A composition comprising the polymer of claim 1.

99. (canceled)

100. A kit comprising:
the polymer of claim 1; and
instructions for using the polymer or composition.

101-106. (canceled)

107. A method of bonding comprising:
applying the polymer of any one of claim 1 to a surface of a first solid substrate; contacting the polymer or composition on the surface of the first solid substrate with a surface of a second solid substrate; and curing the polymer or composition on the surface of the first solid substrate to form bonded first and second substrates; or
applying the polymer or composition to a surface of a first solid substrate and a surface of a second solid substrate; contacting the polymer or composition on the surface of the first solid substrate with the polymer or composition on the surface of the second solid substrate; and curing the polymer or composition on the surface of the first solid substrate and the polymer or composition on the surface of the second solid substrate to form bonded first and second substrates;
wherein the first solid substrate is the same or different from the second solid substrate.

108-114. (canceled)

115. A method of debonding comprising maintaining the bonded first and second substrates recited in claim 107 at a fifth temperature for a fifth time duration sufficient to form debonded first and solid substrates, wherein:
the fifth temperature is between 40 and 60, between 60 and 80, between 80 and 100, between 100 and 120, between 120 and 140, between 140 and 160, between 160 and 180, or between 180 and 200° C., e.g., between 50 and 150° C.; and
the fifth time duration is between 10 and 60 seconds, between 1 and 10 minutes, between 10 and 60 minutes, between 1 and 8 hours, or between 8 and 24 hours, e.g., between 10 seconds and 2 minutes.

116-119. (canceled)
